(19) United States
(12) Patent Application Publication
(10) Pub. No.: US 2023/0224065 A1
(43) Pub. Date: Jul. 13, 2023

(54) OPTICAL TRANSMISSION SYSTEM, OPTICAL RECEIVER, AND OPTICAL TRANSMITTER

(71) Applicant: NIPPON TELEGRAPH AND TELEPHONE CORPORATION, Tokyo (JP)

(72) Inventor: Manabu YOSHINO, Musashino-shi, Tokyo (JP)

(73) Assignee: NIPPON TELEGRAPH AND TELEPHONE CORPORATION, Tokyo (JP)

(21) Appl. No.: 18/018,722

(22) PCT Filed: Aug. 3, 2020
(86) PCT No.: PCT/JP2020/029647

§ 371 Date: Jan. 30, 2023

(51) Int. Cl. H04J 14/02

(52) U.S. Cl. CPC H04J 14/0224; H04J 14/0261

(57) ABSTRACT

An optical transmission system including a plurality of optical transmission devices and an optical reception device and performing communication by wavelength division multiplexing, in which the plurality of optical transmission devices each includes a transmission unit that encodes transmission data on a basis of an allocated code and output the transmission data to an optical transmission line at an allocated wavelength, and different codes are allocated to the plurality of optical transmission devices to which different wavelengths are allocated, and the optical reception device includes one or a plurality of decoding units that decodes the transmission data transmitted from the plurality of optical transmission devices on the basis of an optical signal for each wavelength transmitted via the optical transmission line by wavelength multiplexing division and the allocated code.

### TECHNICAL FIELD

The present invention relates to an optical transmission system, an optical reception device, and an optical transmission device.

### BACKGROUND ART

In an optical transmission system, wavelength division multiplexing using a plurality of wavelengths is performed (see, for example, Patent Literature 1).

### CITATION LIST

### Patent Literature

Patent Literature 1: JP 08-237203 A

### SUMMARY OF INVENTION

### Technical Problem

In the case of an optical network that shares a medium as in Patent Literature 1, there is a possibility that an optical signal of a user or a channel causes a wavelength deviation (wavelength drift, drift) from an allocated wavelength. There has been a problem that communication of an overlapped user is hindered or the optical signal received by another user or channel when there is an overlap with a wavelength of the other user or channel due to the wavelength deviation.

In view of circumstances described above, an object of the present invention is to provide a technique capable of suppressing an influence of the wavelength deviation.

### Solution to Problem

One aspect of the present invention is an optical transmission system including a plurality of optical transmission devices and an optical reception device and performing communication by wavelength division multiplexing, in which the plurality of optical transmission devices each includes a transmission unit that encodes transmission data on the basis of an allocated code and output the transmission data to an optical transmission line at an allocated wavelength, and different codes are allocated to the plurality of optical transmission devices to which different wavelengths are allocated, and the optical reception device includes one or a plurality of decoding units that decodes an optical signal for each wavelength included in a multiplexed signal transmitted via the optical transmission line into the transmission data transmitted from the plurality of optical transmission devices on the basis of the allocated code.

One aspect of the present invention is an optical reception device in the optical transmission system described above.

One aspect of the present invention is an optical transmission device in the optical transmission system described above.

### Advantageous Effects of Invention

According to the present invention, it is possible to suppress the influence of the wavelength deviation.

### BRIEF DESCRIPTION OF DRAWINGS

FIG. 1 is a diagram illustrating a system configuration of an optical transmission system in a first embodiment.

FIG. 2A is a diagram illustrating an example of wavelengths allocated to respective ONUs in the first embodiment.

FIG. 2B is a diagram illustrating an example of codes used for encoding and decoding the respective ONUs in the first embodiment.

FIG. 3 is a sequence diagram illustrating a flow of processing of the optical transmission system in the first embodiment.

FIG. 4 is a diagram for explaining states of signals of a leakage destination and a leakage source due to leakage in the first embodiment.

FIG. 5 is a diagram illustrating a configuration of an OLT in an optical transmission system in a second embodiment.

FIG. 6 is a flowchart illustrating a flow of processing of the OLT in the second embodiment.

FIG. 7 is a diagram for explaining states of signals of a leakage destination and a leakage source due to leakage in the second embodiment.

FIG. 8 is a diagram illustrating a configuration of an OLT in an optical transmission system in a third embodiment.

FIG. 9 is a diagram illustrating an example of demultiplexing characteristics and light transmission of a multiplexer/demultiplexer in the third embodiment.

FIG. 10 is a diagram for explaining states of signals of a leakage destination and a leakage source due to leakage in the third embodiment.

FIG. 11 is a diagram illustrating a configuration of an OLT in an optical transmission system in a fourth embodiment.

FIG. 12 is a diagram for explaining states of signals of a leakage destination and a leakage source due to leakage in the fourth embodiment.

FIG. 13 is a diagram for explaining states of signals of a leakage destination and a leakage source due to leakage in a fifth embodiment.

FIG. 14 is a diagram illustrating a system configuration of an optical transmission system in a sixth embodiment.

FIG. 15 is a diagram illustrating a configuration of an OLT in an optical transmission system in a seventh embodiment.

FIG. 16 is a diagram illustrating a configuration of an OLT in an optical transmission system in an eighth embodiment.

FIG. 17 is a diagram illustrating a configuration of an OLT in an optical transmission system in a ninth embodiment.

FIG. 18A is an explanatory diagram in a case where addition of an error rate is performed and used as a trigger for restoring a wavelength drift.

FIG. 18B is an explanatory diagram in a case where addition of an error rate is performed and used as a trigger for restoring a wavelength drift.

### DESCRIPTION OF EMBODIMENTS

Hereinafter, an embodiment of the present invention will be described with reference to the drawings.

### (Overview)

In an optical transmission system in the present invention, different wavelengths and different codes are allocated to respective optical transmission devices. Then, each of the optical transmission devices transmits an optical signal encoded on the basis of an allocated code at an allocated wavelength. An optical reception device decodes received optical signals for respective wavelengths into transmission data on the basis of the codes associated with the optical transmission devices. As a result, even in a case where an optical signal from an optical transmission device to which an adjacent wavelength is allocated leaks into an optical signal of each wavelength, the signal from the leaking optical transmission device is not easily decoded since the codes are different from each other. It is therefore possible to suppress an influence of wavelength deviation.

Note that an allocation target of the wavelength and the code is the optical transmission device, but may be each of communication devices including the optical transmission device, each of users, each of paths, each of channels, each of services, or a combination thereof. In the following description of this application, these terms are used interchangeably.

The wavelength that leaks or may leak is, for example, an adjacent wavelength. The codes are codes for encoding data to be transmitted, and are, for example, churns or scramblers different in at least one of a generator polynomial or an initial value, such as codes used in code division multiplexing (CDM) or code division multiple access (CDMA), particularly optical, optical CDM or optical CDMA. The optical transmission system in the present invention can be applied to a system that shares at least a part of a transmission line by wavelength division multiplexing (WDM).

Hereinafter, configurations for performing optical decoding will be described in a first embodiment to a fifth embodiment, configurations for performing electrical decoding will be described in a sixth embodiment to a tenth embodiment, and configurations for performing the optical decoding and the electrical decoding will be described in an eleventh embodiment to a fifteenth embodiment.

The optical decoding refers to decoding performed in a state of an optical signal. For example, the optical decoding is decoding that decodes an optical code (for example, an optical orthogonal code (CCC) code, for example, a code using an optical phase), and in the case of the CCC code, the optical decoding is processing for aligning chips approximately to the time of one chip by giving a delay to each of elements constituting a 1-bit signal called a chip or a bin discretely arranged on a time axis so that a sum of a delay given at the time of encoding and a delay given at the time of decoding is constant.

Arrangement of chips in encoding is not limited to the time axis, and may be distributed by, for example, time, wavelength, polarization, phase, mode, or a combination thereof. In decoding of these codes, distributed chips are aligned temporally or a decoder includes a plurality of outputs and aligns the outputs with any of the outputs. In the case of a code in which chips are aligned and only addition is performed, the orthogonality is higher as the number of chips aligned in the code is larger and the number of chips aligned in another code is smaller, but even if the chips of the other code are decoded, the orthogonality does not become non-zero, so that the chips cannot be completely orthogonally decoded. If chips of different codes can cancel each other as an addition side and a subtraction side, the codes are orthogonal to each other. In the case of these codes, in decoding, a larger number of chips of the code are aligned on one of the addition side or the subtraction side, and for the chips of the other code, detection and addition/subtraction is performed, on each of the addition side and the subtraction side, of chips encoded with codes that cancel each other including addition/subtraction after multiplying outputs on the addition side and the subtraction side by coefficients.

In an alignment method, the addition side and the subtraction side may be aligned to different times, and codes that performs alignment to perform detection in synchronization with time may be decoded, or the codes may be decoded by inputting different outputs of the decoder to different detectors, respectively, weighting the outputs of the detectors as necessary, and performing addition/subtraction (differential detection). In this case, decoding is performed by a decoder and a detector (and addition/subtraction of outputs thereof). In a case where addition/subtraction are performed by electrical processing on the output of the detector, decoding is performed by the decoder, the detector, and an electrical processing circuit. In the case of a code in which a positive value and a negative value are possible, for example, a code using a phase of light, in the case of the code, alignment is performed as chips of positive values or negative values to be overlapped, and in the case of the other code, decoding is performed so that chips substantially cancel each other as a chip of a positive value and a chip of a negative value.

Although the decoding of the code in which the chip is discretely represented has been described, a code including continuous elements may be decoded. For example, in the case of a code whose wavelength continuously changes temporally, for example, a code similar to a time change of the wavelength due to a chirp of a laser or the like and due to a shape of the change, for example, a difference in change rate, the output of the code is detected using a filter depending on a wavelength change of the code as a decoder, or a wavelength of local light is changed in synchronization with the time change of the wavelength of the optical signal by coherent detection without using the decoder itself, and the code is decoded at the same intermediate frequency, or the output of the intermediate frequency depending on a change in optical frequency difference with the local light of a fixed wavelength is selected and decoded as the electrical processing. Even in the case of such a code, it is also possible to select a wavelength synchronized with the code in a form of shifting the wavelength, reduce the received output, and perform differential detection and decoding.

In the optical decoding, a circuit corresponding to a decoder for electrically decoding an electrically encoded code may be configured by an optical element, and the electrically encoded code may be decoded. The optical decoding is decoding that can reduce electrical processing in decoding. In many cases, the same applies to encoding.

The electrical decoding refers to decoding performed in a state of an electrical signal. For example, the electrical decoding is decoding in a churn or a scrambler. That is, decoding is performed by a shift register or a decoder similar thereto. However, since the purpose is to perform separation when signals of different channels are superimposed on each other, without passing through an identification device that identifies, or identifies and reproduces a bit or the like for 0/1 determination or the like before decoding by a decoder, the, optical reception device, as in the second to fifth embodiments, the seventh embodiment to the tenth embodiment, and the twelfth embodiment to the fifteenth embodiment described below, detects a signal that has leaked to a wavelength of another channel and adds the signal to the signal of the leakage source, subtracts the signal from an output of a channel itself to which the signal has leaked, or creates a duplicate of the signal of the leakage source and subtracts the signal leaking to a host channel, and then identifies, identifies and reproduces the signal, or performs maximum likelihood determination, to decode the signal.

Decoding similar to the shift register exemplified in the electrical decoding can be decoded by a decoder configured with an electrical circuit including an electrical splitter, delay line, and adder, but can also be optically decoded by a decoder configured with an optical coupler/splitter (such as an optical splitter), delay line, and coupler/splitter (such as an optical coupler). In the case of the optical configuration, it is desirable to configure a circuit in which a phase difference between a plurality of paths does not fluctuate so that a beat does not fluctuate. Note that weighting for each delay in the decoder may be weighted by a splitting ratio of a splitter, a loss or gain addition or the like for each delay line.

Similarly, even in the case of encoding with a shift register or the like normally corresponding to a predetermined initial value or generator polynomial, for example, encoding with a churn or a scrambler, it is possible to perform optical encoding by configuring an optical circuit corresponding thereto.

Conversely, an optically encoded code such as CCC may be electrically decoded. In the case of the CCC, it is sufficient to perform addition of a delayed output corresponding to a chip, and the same applies to other codes as long as addition/subtraction are performed. If a signal after optical detection can be converted by an analog-digital converter (ADC) or the like having a sufficiently fine time granularity, for example, a granularity less than or equal to a chip time, and a sufficiently fine strength granularity, for example, a strength equivalent to one chip, instead of using an analog electrical circuit depending on a code, decoding is performed by digital processing using a digital signal processor (DSP) or the like. Here, regarding the granularity, as long as codes can be identified, the time granularity and the strength granularity may be larger than those of the chip. The digital processing may be used instead of the above-described electrical decoding of a decoder or the like similar to the shift register, or may be appropriately combined with the optical decoding.

As the electrical decoding, an electrical signal that is a source when light is modulated and modulated as an optical signal may be decoded. For example, in a case where encoding is performed in a time domain or a frequency domain as used in a mobile phone or the like, decoding is performed using fast Fourier transform (FFT), inverse fast Fourier transform (IFFT), or the like as necessary depending on a code used for encoding. The code to be optically decoded may also be similarly subjected to digital processing and encoded via a digital analog converter (DAC).

The optical decoding and the electrical decoding are a combination thereof, and any one may be used for each code or ONU, or a part of processing related to one code may be proportionally distributed. Regarding the proportional distribution, for example, fixed processing is optically performed, and processing to be changed for each ONU is electrically performed.

As described above, in a case where the optical decoding is performed in the optical reception device, optical encoding is performed in the optical transmission device, and in a case where the electrical decoding is performed in the optical reception device, electrical encoding is performed in the optical transmission device, and in a case where the optical decoding and the electrical decoding are performed in the optical reception device, the optical decoding and the electrical decoding are generally performed in the optical transmission device, but it is not limited thereto.

### First Embodiment

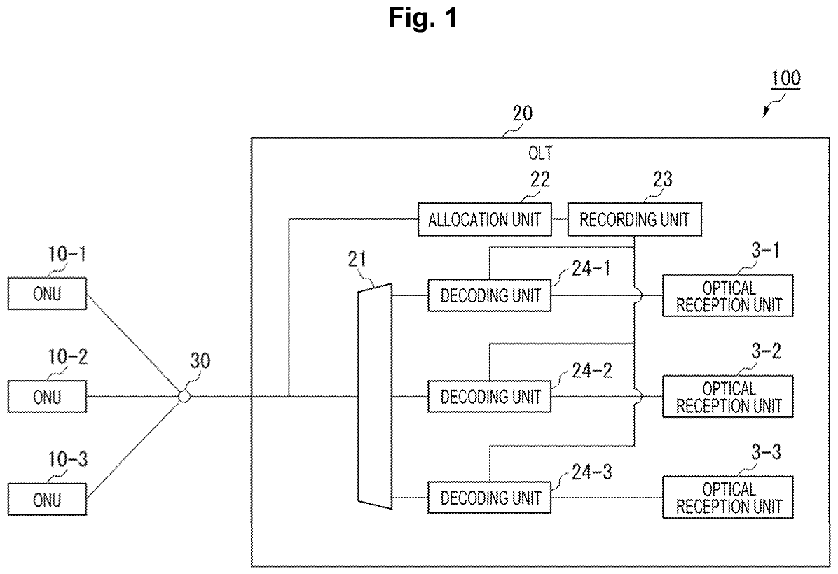

FIG. 1 is a diagram illustrating a system configuration of an optical transmission system 100 in the first embodiment. In the following description, as the optical transmission system 100, as an example, a description will be given of an uplink of a passive optical network (PON) that is a 1-to-N network with M as 1 in an M-to-N network for simplification of description.

The optical transmission system 100 includes a plurality of optical network units (ONUs) 10-1 to 10-3, an optical line terminal (OLT) 20, and an optical splitter 30. The plurality of ONUs 10-1 to 10-3 and the OLT 20 are communicably connected to each other via the optical splitter 30. The plurality of ONUs 10-1 to 10-3 are connected to the optical splitter 30 by optical fibers, and the OLT 20 is connected to the optical splitter 30 by an optical fiber. In the case of uplink communication from the ONUs to the OLT, the plurality of ONUs 10 correspond to the optical transmission devices described in (Overview). The OLT 20 corresponds to the optical reception device described in (Overview). In the case of a downlink, the opposite is true.

In the following description, the ONUs 10-1 to 10-3 will be referred to as ONUs 10 unless otherwise distinguished. In the optical transmission system 100 illustrated in FIG. 1, a configuration is illustrated including three ONUs 10 and one OLT 20, but the number of the ONUs 10 and the number of the OLTs 20 are not limited to those described above. For example, the number of the ONUs 10 only needs to be N (N is an integer of greater than or equal to 1 from a viewpoint of not being received as a signal of another ONU, and is an integer of greater than or equal to 2 from a viewpoint of reducing an influence on a signal of another ONU), and the number of the OLTs 20 may be M (M is an integer of greater than or equal to 1), which is an N-to-M connection. Also in the following embodiments, the number of the ONUs 10 and the number of the OLTs 20 are not limited to those described above.

The ONU 10 is an optical line terminal installed in a customer's home. The ONU 10 performs encoding on the basis of a code allocated from the OLT 20, and transmits, to the OLT 20, an optical signal having a wavelength allocated from the OLT 20. For example, the ONU 10 performs optical encoding on the basis of the allocated code (for example, an CCC code having a predetermined value).

Here, as the optical encoding, exemplification is performed with an CCC code, but other codes may be used, and for example, even in the case of encoding with a shift register or the like normally corresponding to a predetermined initial value or generator polynomial, for example, encoding with a churn or a scrambler, it is possible to perform optical encoding by configuring an optical circuit corresponding thereto. Conversely, even in the case of an optical code, electrical encoding may be performed. The same applies to the following embodiments.

As described above, the ONU 10 includes at least a transmission unit that encodes transmission data on the basis of the allocated code and outputs the transmission data to the optical transmission line at the allocated wavelength.

The OLT 20 is an optical subscriber line terminal installed in an office building. The OLT 20 allocates different wavelengths to the respective ONUs 10. For example, the OLT 20 allocates adjacent wavelengths between the ONUs 10 as the different wavelengths. The adjacent wavelengths are wavelengths adjacent to each other. For example, in a case where there are wavelengths λ1, λ2, λ3, . . . in ascending order or descending order with a predetermined wavelength width, when the wavelength λ2 is focused, the wavelength λ1 and the wavelength λ3 are adjacent wavelengths of the wavelength λ2. Here, the predetermined wavelength width is, for example, a wavelength width corresponding to a frequency width of greater than or equal to ½ of a bit rate, a baud rate, or a symbol rate of a signal transmitted with a 3 dB width. In addition, center wavelengths of the adjacent wavelengths are separated from each other to at least such an extent that the center wavelengths can be separated from the adjacent wavelengths by, for example, a multiplexer/demultiplexer or a filter, and are separated from each other to such an extent that a wavelength width corresponding to a frequency width of greater than or equal to ½ of a bit rate, a baud rate, or a symbol rate of a signal transmitted by a 3 dB width of each transmission wavelength can be secured.

In the following description, it is assumed that the OLT 20 allocates the wavelength λ1 to the ONU 10-1, allocates the wavelength λ2 to the ONU 10-2, and allocates the wavelength λ3 to the ONU 10-3. The OLT 20 allocates, to the ONUs 10, wavelengths adjacent to those for other ONUs 10 as described above, and in a case where wavelengths that may cause wavelength drift are adjacent wavelengths, the OLT 20 allocates at least different codes between the ONUs 10 to which the adjacent wavelengths are allocated. For example, the OLT 20 performs allocation so that at least code are different from each other between the ONUs 10 to which adjacent wavelengths, which are wavelengths that may drift, are allocated.

The optical splitter 30, which is also referred to as an optical coupler, is a distributor that distributes and aggregates optical signals between the ONUs 10 and the OLT 20. For example, the optical splitter 30 distributes an optical signal in the downlink communication direction transmitted from the OLT 20 to the ONUs 10, aggregates optical signals in the uplink communication direction transmitted from the ONUs 10, and transmits the optical signals to the OLT 20.

Examples of the optical encoder and decoder include a planar lightwave circuit (PLC) represented by an arrayed-waveguide grating (AWG) and the like, a fiber Bragg grating (FBG), liquid crystal on silicon (LCOS), and the like, and elements combining them.

Next, an internal configuration of the OLT 20 will be described.

The OLT 20 includes a multiplexer/demultiplexer 21, an allocation unit 22, a recording unit 23, a plurality of decoding units 24-1 to 24-3, and a plurality of optical reception units 3-1 to 3-3. In the following description, the decoding units 24-1 to 24-3 will be referred to as decoding units 24 unless otherwise distinguished. In the following description, the optical reception units 3-1 to 3-3 will be referred to as optical reception units 3 unless otherwise distinguished.

Note that, in a case where an encoding unit (encoder) of the ONU 10 or the decoding unit 24 of the OLT 20 is fixed, the allocation unit 22 (holds its fixed value and) allocates only a wavelength and holds information of the allocated wavelengths in the recording unit 23. At the time of allocation, the allocation unit 22 allocates the wavelength so that a code corresponds to the wavelength multiplexed/demultiplexed by the multiplexer/demultiplexer 21. In a case where a predetermined code and a wavelength to be multiplexed/demultiplexed by the multiplexer/demultiplexer 21 are set in advance for each device, the allocation unit 22 may allocate the wavelength and the code by wavelength allocation or code allocation.

Hereinafter, it is described that the allocation unit 22 can arbitrarily allocate a wavelength and a code, and selects a wavelength to be transmitted or demultiplexed or a code for encoding or decoding with reference to the allocation; however, in a case where the wavelength and the code cannot be selected and are fixed due to limitations of a transmitter, a multiplexer/demultiplexer, an encoder, and a decoder, those devices operate with unique wavelengths and codes, and the allocation unit 22 performs setting depending on the wavelengths and the codes of those devices. In this case, reference operation described later is unnecessary. For example, an encoder, a decoder, a multiplexer/demultiplexer, or the like configured in an analog manner is highly likely to have limitations.

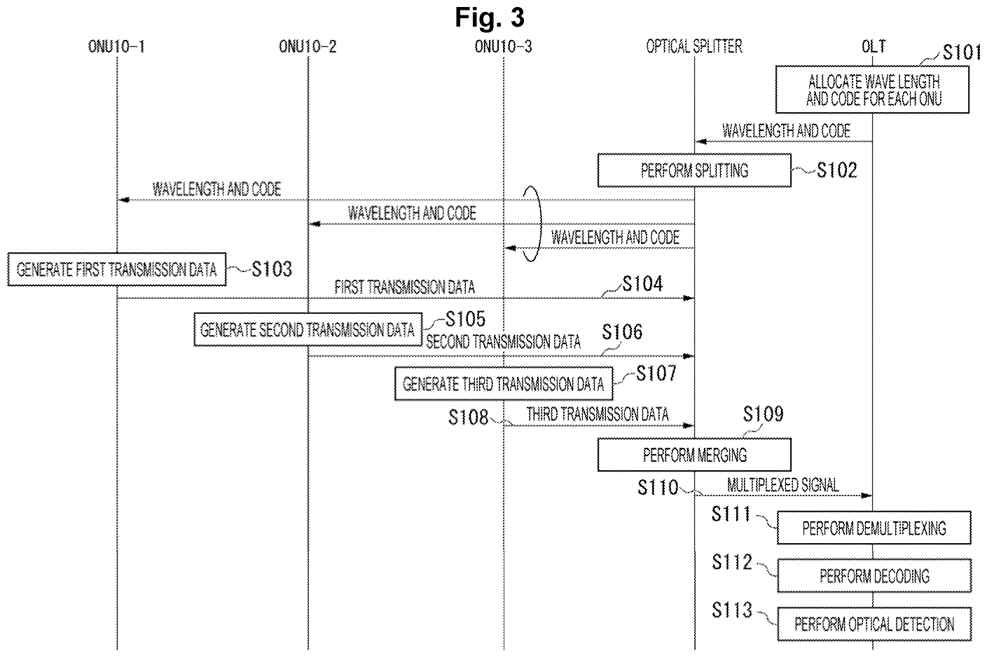

In FIG. 3, an example is illustrated in which the allocation unit 22 allocates a set of the wavelength to be transmitted to the ONU 10 and the code for encoding, but similarly, a set of the wavelength to be received and the code for decoding may be allocated to the OLT 20.

The multiplexer/demultiplexer 21 demultiplexes an input optical signal at a wavelength associated each ONU 10 or channel. Optical signals demultiplexed by the multiplexer/demultiplexer 21 are input to the decoding units 24-1 to 24-3. In FIG. 1, for simplification of description, a configuration is illustrated in which the multiplexer/demultiplexer 21 performs demultiplexing to wavelengths of three channels of the channel 1 to 3, but it is sufficient that the multiplexer/demultiplexer 21 performs demultiplexing to wavelengths of greater than or equal to two channels. For that reason, the number of the decoding units 24 changes depending on the wavelength of each channel demultiplexed by the multiplexer/demultiplexer 21.

The allocation unit 22 allocates a wavelength and a code to each ONU 10. For example, the allocation unit 22 performs wavelength allocation and a code allocation on each ONU 10. Note that, in the present embodiment, from a viewpoint of reducing an influence of leakage, it is more desirable to allocate a code having high orthogonality to each ONU 10. It is desirable to maintain orthogonality between codes applied to each ONU 10, that is, to each channel, depending on a range in which drift is considered to occur. For example, if a drift width is less than twice a channel interval, the range is at least for adjacent channels, if the drift width is for five channels, the range is for four channels in a direction of drift, and if the drift occurs equally for both sides, the range is for two channels on the short wavelength side and two channels on the long wavelength side. Here, the drift means that the wavelength to be transmitted by the transmitter deviates from the allocated wavelength, particularly deviates to such an extent as to leak to an adjacent wavelength.

Information on each ONU 10 is recorded in the recording unit 23. Specifically, the recording unit 23 records information on the wavelength and the code in association with each ONU 10.

The decoding units 24-1 to 24-3 decode the input optical signals by performing decoding with the allocated codes for the wavelengths allocated to the respective ONUs 10 on the basis of the information on the wavelength and the code recorded in the recording unit 23. The decoding unit 24 corresponds to the decoder described above.

Branch numbers of the decoding units 24-1 to 24-3 represent corresponding channels of the respective decoding units 24. For example, the decoding unit 24-1 decodes the optical signal output from an output for the channel 1 of the multiplexer/demultiplexer 21. For example, the decoding unit 24-2 decodes the optical signal output from an output for the channel 2 of the multiplexer/demultiplexer 21 alone or in combination with an optical receiver or the like. For example, the decoding unit 24-3 decodes the optical signal output from an output for the channel 3 of the multiplexer/demultiplexer 21. For example, the decoding unit 24-3 outputs the optical signal output from the output for the channel 3 of the multiplexer/demultiplexer 21 to a plurality of ports, and performs decoding by performing differential detection or the like on output of each port by the optical reception unit 3.

In the configuration including the decoding units 24-1 to 24-3, the optical reception units 3-1 to 3-3 receive the optical signals output from the decoding units 24-1 to 24-3. The optical reception units 3-1 to 3-3 include any of one or a plurality of receivers for direct detection, a differential detector, or a coherent receiver including a digital coherent (DC). Which receiver is to be included depends on a code to be used, a modulation method, and the like. The plurality of optical reception units 3-1 to 3-3 having different wavelengths to be received can also be formed into one receiver by making an intermediate frequency, which is a light frequency difference between an optical signal and local light, different for each wavelength to be received to such an extent that a signal can be demodulated. The optical reception units 3-1 to 3-3 convert the received optical signal into an electrical signal and output the electrical signal to a processing unit at the subsequent stage. The optical reception units 3-1 to 3-3 are provided for respective wavelengths associated with the ONUS 10. For example, one optical reception unit 3 receives an optical signal having a wavelength for one ONU 10. As in an embodiment described later, an optical signal of a wavelength for one ONU 10 may be received for each of the plurality of decoding units 24.

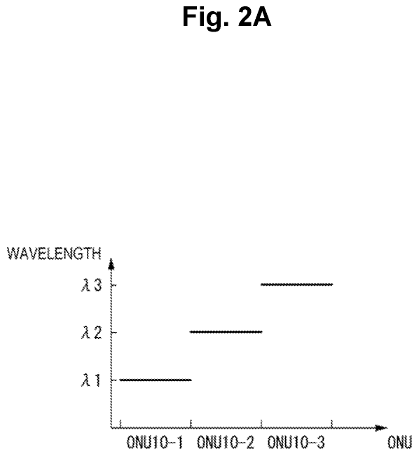

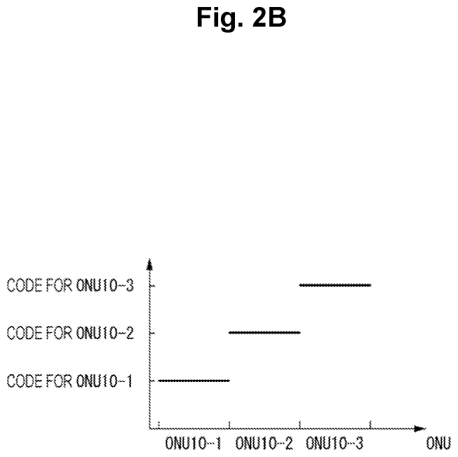

FIG. 2A is a diagram illustrating an example of wavelengths for the respective ONUs 10. In FIG. 2A, a horizontal axis represents an ONU, and a vertical axis represents a wavelength or an optical frequency. Note that, since the wavelength and the optical frequency have an inverse relationship, the directions of the arrows are opposite between the case of the wavelength and the case of the optical frequency. The optical frequency is often used in the case of coherent reception or the like using an intermediate frequency that is a light frequency difference between local light and an optical signal. The example illustrated in FIG. 2A illustrates that the wavelength λ1 is allocated to the ONU 10-1, the wavelength λ2 is allocated to the ONU 10-2, and the wavelength λ3 is allocated to the ONU 10-3.

FIG. 2B is a diagram illustrating an example of codes used for encoding and decoding of the respective ONUs 10. As illustrated in FIG. 2B, an optical signal can be decoded when information used for encoding by each ONU 10 matches information used for decoding by the OLT 20. In the first embodiment, the same code as the code used for encoding is used as the code used for decoding. In the embodiments described later, in addition to the same code, a code allocated to an ONU 10 whose wavelength is likely to leak may also be used as a code used for decoding. These are used for identification of leakage, mitigation of influence on a leakage destination, and reinforcement of a signal of a leakage source.

FIG. 3 is a sequence diagram illustrating a flow of processing of the optical transmission system 100 in the first embodiment.

The allocation unit 22 allocates a wavelength and a code for each ONU 10 (step S101). For example, it is assumed that the allocation unit 22 allocates the wavelength λ1 and a first code to the ONU 10-1, allocates the wavelength λ2 and a second code to the ONU 10-2, and allocates the wavelength λ3 and a third code to the ONU 10-3.

As described above, the allocation unit 22 varies the codes to be allocated in the ONUs 10 to which wavelengths corresponding to wavelengths in a range in which a wavelength of a certain ONU 10 may drift are allocated. On the other hand, the allocation unit 22 may allocate the same code to the ONUs 10 corresponding to wavelengths in a range that are less likely to drift. Here, the adjacent wavelengths are set to a range in which there is a possibility of drift, and the allocation unit 22 allocates at least different codes between the ONUs 10 to which the adjacent wavelengths are allocated. In the case of FIG. 3, adjacent wavelengths are allocated to the ONU 10-1 and the ONU 10-2, and the ONU 10-2 and the ONU 10-3.

Thus, the allocation unit 22 allocates different codes to the ONU 10-2 to which the wavelength λ2 is allocated and the ONU 10-1 to which the wavelength λ1 is allocated. Further, the allocation unit 22 allocates different codes to the ONU 10-2 to which the wavelength λ2 is allocated and the ONU 10-3 to which the wavelength λ3 is allocated.

The allocation unit 22 outputs an optical signal including information on the allocated wavelength and code to the optical fiber. The optical splitter 30 splits the optical signal transmitted from the OLT 20 (step S102). That is, the optical splitter 30 broadcasts the optical signal transmitted from the OLT 20. The optical signal split by the optical splitter 30 is input to each of the ONUs 10-1 to 10-3.

Each of the ONUs 10-1 to 10-3 acquires information on the wavelength and code allocated thereto from the input optical signal.

Here, an example has been described in which the wavelength and the code are allocated by broadcasting the optical signal from the OLT 20 to the ONU 10, and each ONU 10 acquires the information allocated to itself, but it is not limited thereto. Logically, communication may be performed by unicast, or allocation may be performed using other paths, for example, other lines or means such as a wireless line. The same applies to the following embodiments.

The allocation unit 22 records the wavelength and the code allocated to each ONU 10 in the recording unit 23. Note that, instead of each ONU 10, the allocation unit 22 may associate the wavelength and the code with each user or each channel, and a combination thereof may be recorded in the recording unit 23. The same applies to the following embodiments.

The ONUs 10-1 to 10-3 generate first to third transmission data by using the first to third codes, respectively (steps S103, S105, and S107). As an example, a description will be given of the first transmission data generated by the ONU 10-1 to which an CCC code of a certain value is allocated. The ONU 10-1 generates first transmission data by encoding, with an CCC encoder, an optical signal obtained by modulating a pulse of one chip width with a value of a bit every one bit time. Note that, in a case where the ONUs 10-1 to 10-3 electrically generate signals of CCC codes, 1-bit signals are converted into codes including a plurality of discretely arranged chips, and the codes are modulated in units of bits to generate transmission data. The ONUs 10-1 to 10-3 transmit the generated first to third transmission data to the OLT 20 at the allocated wavelengths, respectively (steps S104, S106, and S108).

The first transmission data, the second transmission data, and the third transmission data transmitted from the respective ONUs 10-1 to 10-3 are input to the optical splitter 30. The optical splitter 30 generates a multiplexed signal by merging the first transmission data, the second transmission data, and the third transmission data (step S109). The optical splitter 30 outputs the multiplexed signal to the OLT 20 (step S110).

Here, for convenience of description for each ONU 10, FIG. 3 illustrates that signals are retained in the optical splitter 30 until the transmission data of the ONUs 10-1 to 10-3 are prepared, and after the prepared transmission data are prepared, the signals are collectively output as the multiplexed signal. Actually, the optical splitter 30 sequentially outputs the signals without retaining them.

The OLT 20 receives the multiplexed signal output from the optical splitter 30. The multiplexer/demultiplexer 21 demultiplexes the input multiplexed signal at the wavelength of each channel (step S111). For example, the multiplexer/demultiplexer 21 demultiplexes the input multiplexed signal at the wavelength of the channel 1, the wavelength of the channel 2, and the wavelength of the channel 3. As a result, the optical signal having the wavelength λ1 is input to the decoding unit 24-1, the optical signal having the wavelength λ2 is input to the decoding unit 24-2, and the optical signal having the wavelength λ3 is input to the decoding unit 24-3.

The decoding units 24-1 to 24-3 decode the input optical signal on the basis of the information recorded in the recording unit 23 (step S112). The decoding unit 24-1 will be specifically described as an example. First, the decoding unit 24-1 refers to the recording unit 23 and acquires information on a code associated with the ONU 10-1 (for example, information on the first code). Next, the decoding unit 24-1 decodes the optical signal by decoding the input optical signal with the first code on the basis of the acquired information on the code.

The decoding units 24-1 to 24-3 output optical signals to the optical reception units 3-1 to 3-3. The optical reception units 3-1 to 3-3 convert the optical signal into an electrical signal by performing optical detection on the input optical signal (step S113).

When the wavelength of a certain ONU 10 drifts to such an extent as to reach the wavelength allocated to another ONU 10, the drifting signal is not correctly restored to the original signal because the code to be decoded at the wavelength is different from the encoded code. For example, when the wavelength λ1 of the ONU 10-1 drifts to such an extent as to reach the wavelength λ2 allocated to the ONU 10-2, the code to be decoded associated with the wavelength λ2 is different from the code associated with the wavelength λ1 used for encoding by the ONU 10-1. For that reason, the signal having the drifting wavelength λ1 of the ONU 10-1 cannot be correctly decoded by the decoding unit 24-2 having the wavelength the optical reception unit 3-2, and an electrical signal processing unit (not illustrated). For this reason, the signal of the ONU 10-1 whose wavelength drifts is not correctly received by the optical reception unit 3-2 having the wavelength of a drift destination, and mainly becomes noise.

In the optical reception unit 3 having the wavelength of a drift source, only the signal of a component remaining without drifting is correctly decoded and received. For that reason, at least the drifting signal is not subjected to decoding or the like, so that the signal strength decreases and the communication quality degrades. Note that, unlike the present application, in a case where the code is not different for each wavelength, that is, for each ONU 10, when an optical signal of another ONU 10 that should have a different wavelength from a certain ONU 10 leaks, there is a possibility that the leaking optical signal is added or decoded as a received signal of the ONU 10 when decoding is performed with the same code.

In a reception signal of each of the ONUS 10 to which leakage has occurred, the orthogonality between codes decreases, and the reception strength of a signal after decoding by a decoder corresponding to the wavelength at a receiver at the leaking wavelength decrease depending on a value of the signal. In the case of being orthogonal, if the beats of the optical signals do not overlap the signal band, only the shot noise of leakage occurs. If they overlap, beat noise is also added. In the beat noise, If both are not in a coherent relationship and continuous light and the same polarization, the phase relationship varies unless special processing is performed, so that the strength varies, and the maximum value thereof is (signal strength×leakage strength)\hat{ }0.5 and the average thereof is half. Note that, there is also an influence of the line width of the optical signal.

In the present application, there is a region where the influence of wavelength deviation can be mitigated, but the influence of leakage due to the beat noise cannot be avoided in a situation where it cannot be ignored. As in the embodiment described later, it is effective to issue an instruction to restore the wavelength of the ONU 10 that is the leakage source. Although this instruction to restore the wavelength is explicitly described only in the second embodiment, the seventh embodiment, and the twelfth embodiment, it is desirable to combine that in other embodiments. In particular, a notification may be made before the beat noise cannot be ignored.

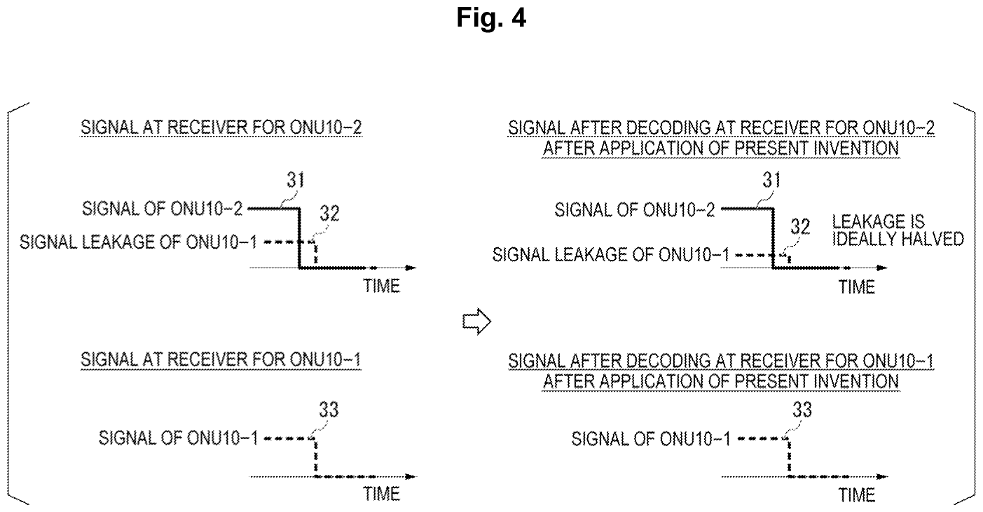

FIG. 4 is a diagram for explaining states of signals of a leakage destination and a leakage source due to leakage in the first embodiment. FIG. 4 illustrates a situation in which the reception strength of the signal of the leaking wavelength after decoding decreases in a case where the codes are not orthogonal to each other and scrambling is different. An upper left diagram in FIG. 4 illustrates a state of a signal in the receiver for the ONU 10-2 (in the example of FIG. 1, the optical reception unit 3-2) before the processing according to the present invention is applied, and a lower left diagram in FIG. 4 illustrates a state of a signal in the receiver for the ONU 10-1 (in the example of FIG. 1, the optical reception unit 3-1) before the processing according to the present invention is applied. An upper right diagram in FIG. 4 illustrates a state of a decoded signal in the receiver for the ONU 10-2 after the processing according to the present invention is applied, and a lower right diagram in FIG. 4 illustrates a state of a decoded signal in the receiver for the ONU 10-1 after the processing according to the present invention is applied. In the schematic diagram illustrated in FIG. 4, a loss due to the decoding unit 24 and the like, a difference due to a code, a characteristic of a device, and the like are ignored. The same applies to the figures described later.

In the upper left diagram in FIG. 4, a leakage 32 of the signal of the ONU 10-1 is illustrated in a signal 31 of the ONU 10-2 received by the receiver for the ONU 10-2. That is, a situation is illustrated in which the leakage 32 of another wavelength (for example, λ1) occurs in the signal 31 of the wavelength λ2 of the ONU 10-2. The upper right diagram in FIG. 4 illustrates a situation in which the leakage 32 decreases after decoding. For example, in a case where orthogonality between codes is negligible, and modulation is binary modulation of ON/OFF, and appearance ratio of 1 and 0 is 1:1 due to scrambling or the like, and appearance of I/O is almost random, and one bit time for each wavelength is the same, and complementary reception such as differential detection is not performed, if 1 and 0 are half overlapped with each other in one bit due to a half clock shift, the same code is continuous, and in the worst case, if an influence of the same code continuation is ignored, in a case where scramblers or the like are different, the received signal is re-spread and averaged, and probabilistically, leakage is ideally halved.

If the appearance ratio is P:Q, it can be probabilistically mitigated to P/(P+Q). Here, an effect of shot noise due to leakage is ignored because it is small.

Note that, if there is a plurality of chips in one bit, the chips are complementarily received, and the codes are orthogonal to each other, leakage can be ignored. In a case where encoding is performed into codes orthogonal to each other in a case where bit shifting is not performed, for example, in a case where encoding is complementarily performed into a combination of 1 being “1010” and 0 being “0101” and a combination of 1 being “1100” and 0 being “0011”, the number of combinations that can mitigate the influence increases particularly in a case where bit shifting is not performed. It can be further mitigated in a case where codes that can be subtracted are used and encoding is performed with phases such as “1” and “−1”, “0” and “n”, and “n/2” and “3n/2” instead of “1” and “0”, or encoding is performed that complementarily performs decoding by performing addition of a value in the case of 1 and performing subtraction of an input in the case of 0.

In a case where the initial values of a churn and a scrambler are allocated in the embodiment of the subsequent stage, mitigation is performed under a situation where the bit shifts are not mutually performed, and in a case where allocation is performed by a generator polynomial or the like, orthogonality increases by selecting a generator polynomial that generates bit strings more orthogonal to each other. In a case where a wavelength code is used as the code, mitigation can be made easier by using a code in which a relationship between codes is maintained even if the wavelength deviates. For example, those are encoding and decoding in which in a case where a code in which light is emitted in λ1, λ3, λ5, and λ7 at 1, and in λ2, λ4, λ6, and λ8 at 0 is used, the light is emitted in λ3, λ5, λ7, and λ9 at 1, and in λ4, λ6, λ8, and λ10 at 0 even if the wavelength is shifted.

It is desirable that the ONUs 10-1 to 10-3 have a mechanism for restoring wavelength drift from communication quality degradation such as signal degrade (SD) due to strength degradation or the like associated with wavelength drift or signal degradation of an upper layer. Specifically, regarding the code of a leaking side, the signal degradation occurs due to a decrease in strength, and it is used as a trigger for wavelength control of the device. A time lapse of degradation due to degradation over time of a transmitter may be identified from a transition of the signal degradation with respect to the time lapse, and degradation due to degradation of a transmission line shared by a plurality of optical transmission devices may be identified by whether or not degradations of signals corresponding to the plurality of optical transmission devices are synchronized. Regarding an increase in the signal strength and the code of a side to which leakage has occurred, the signal strength increases but the signal degrades, so that, depending on a combination thereof, an instruction for wavelength control may be issued to the optical transmission devices that share at least a part of the transmission line, or the instruction may be issued to the transmitters with signal degradation and strength degradation of multiple transmitters synchronized with the degradation.

According to the optical transmission system 100 configured as described above, the OLT 20 includes the allocation unit 22 that allocates different wavelengths to the respective plurality of ONUs 10, and allocates at least different codes to the wavelengths allocated to the ONUs 10 that may leak, here, the ONUs 10 to which adjacent wavelengths are allocated, and the decoding units 24 that decode the transmission data transmitted from the plurality of ONUs 10 using the codes associated with the respective allocated wavelengths. As described above, the decoding units 24 decode the transmission data of the respective ONUS 10 on the basis of the codes associated with the respective wavelengths. As a result, even in a case where an adjacent wavelength leaks, a signal of the leaking wavelength is not easily decoded at the leakage destination. It is therefore possible to reduce the influence of the wavelength deviation, particularly, a risk of communicating with an unintended communication destination.

A modification of the first embodiment will be described.

As the OLT 20 in the first embodiment, a configuration has been described in which the multiplexed signal is demultiplexed for each wavelength by the multiplexer/demultiplexer 21. The OLT 20 may include a coupler/splitter instead of the multiplexer/demultiplexer 21, and may include filters that transmit optical signals of specific wavelengths at the subsequent stage of the coupler/splitter. The coupler/splitter distributes the optical signals (multiplexed signal) aggregated by the optical splitter 30 to the filters provided at the subsequent stage. The filters are provided at the preceding stages of the respective decoding units 24 and transmit the specific wavelengths. For example, the filter provided at the preceding stage of the decoding unit 24-1 is set to transmit the optical signal having the wavelength λ1. For example, the filter provided at the preceding stage of the decoding unit 24-2 is set to transmit the optical signal having the wavelength λ2. For example, the filter provided at the preceding stage of the decoding unit 24-3 is set to transmit the optical signal having the wavelength λ3. Note that, in the present embodiment, since a demultiplexed signal is input to one decoding unit 24, if the order is reversed so that the demultiplexed signal is input to the plurality of decoding units 24, the order of the decoding unit 24 and the filter can be set without receiving a disadvantage that the number of filters increases, unlike a later-described embodiment in which the number of filters increases.

As the OLT 20 in the first embodiment, a configuration has been described in which the plurality of decoding units 24 is included. On the other hand, in a case where the OLT 20 communicates with only a specific ONU 10, the OLT 20 only needs to include one decoding unit 24. In the case of such a configuration, the OLT 20 includes the allocation unit 22, the recording unit 23, one decoding unit 24, one demultiplexer or filter, and the optical reception unit 3. Then, the OLT 20 inputs the multiplexed signal received via the transmission line to the filter and extracts an optical signal of a specific wavelength. The decoding unit 24 decodes an optical signal by decoding the extracted optical signal with a code in the codes associated with the wavelengths.

As described above, even in a case where the OLT 20 communicates only with a specific ONU 10, communication may be performed in an M-to-N connection with the number of OLTs 20 being M. In the case of such a configuration, the following configuration may be adopted as an example. For example, in a case where the M OLTs 20 select and receive a signal of one ONU 10 in a wavelength-multiplexed signal from the N ONUS 10, each OLT 20 only needs to receive an optical signal of a wavelength corresponding to the ONU 10 that transmits a signal to the OLT 20, and thus, only needs to include a filter that filters only a wavelength to the OLT 20. In particular, in such a configuration, the allocation unit 22 and the recording unit 23 may be provided at a different location in the network instead of the OLT 20. It only needs to be a location in which the ONU 10 and the OLT 20 can be notified of at least allocated wavelengths and codes, and the allocation unit 22 and the recording unit 23 may be provided in the ONU 10, or in a distributed manner in a plurality of devices, and notification may be performed via another path including wireless communication. The same applies to other configurations described above and the following embodiments.

### Second Embodiment

In the second embodiment, in an OLT, an optical signal demultiplexed at a wavelength of each ONU or channel is decoded by including not only a decoding unit that decodes a code corresponding to an optical signal of the ONU, that is, the wavelength, but also a decoding unit that decodes a code of an optical signal of an ONU that may cause drift, for example, an ONU of an adjacent wavelength. Then, the OLT detects presence or absence of a signal decoded with a code of an ONU that may cause drift, and detects presence or absence of a wavelength of an ONU or a channel that may cause drift, for example, a leaking optical signal due to a drift of a signal of an adjacent wavelength. Detection of the presence or absence of the decoded signal may be based on extraction of a user signal, a control signal, or a fixed pattern such as a preamble, a characteristic pattern, a clock signal, or the like associated therewith. For example, in a case where a clock or a user signal, a control signal or a clock, or the like can be extracted, the OLT detects presence of leakage. In a case where codes are orthogonal to each other and a code from which interference can be eliminated is used, the presence of leakage may mean that an output of decoding with a code other than the code corresponding to the ONU has a strength that can be regarded as non-zero.

In addition, depending on the orthogonality of the codes, even in a case where the optical signal of the ONU that is an original reception target is decoded with another code, the output does not become non-zero, and a possibility of erroneous detection of the presence of leakage increases. In that case, it is sufficient that identification is performed by setting a threshold based on a result of decoding with another code for the signal of the ONU that is the reception target. Since the result of decoding depends on a value and strength of the signal of the ONU that is the reception target, a threshold may be set to: for example, an output of decoding of another code depending on the value and strength of the signal of the ONU that is the reception target; for example, the output of decoding of the other code depending on the strength in a case where the value of the signal is set to a value of the signal in which the result of decoding with the other code is the largest; for example, the output of decoding of the other code in a case where the value of the signal is set to the value of the signal in which the result of decoding with the other code is the largest and the value of the signal of the ONU that is the reception target is a predetermined value such as the maximum strength; for example, the output of decoding of the other code depending on average strength in a case where the value of the signal is a value of a signal at which the result of decoding with the other code is an average; or for example, a value obtained by adding noise or the like on the reception side such as shot noise to any of these outputs.

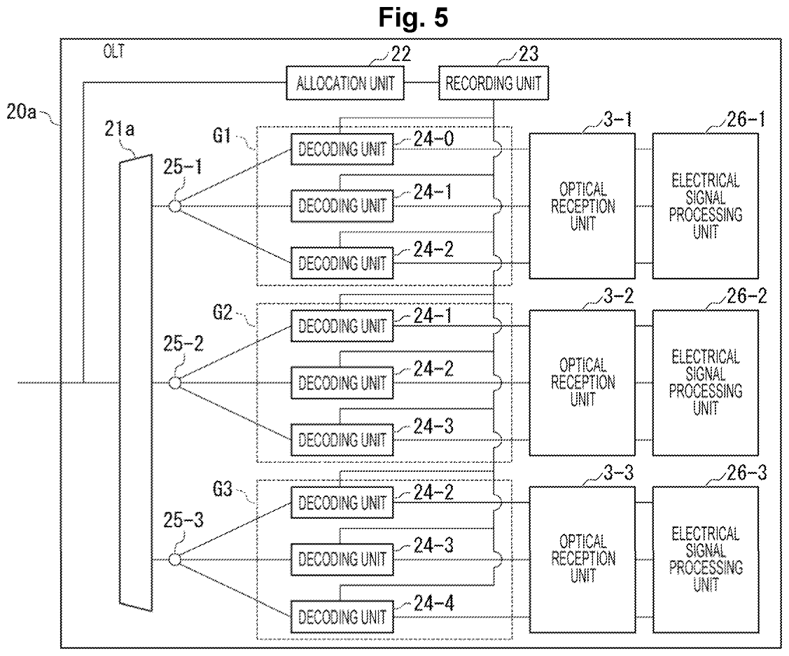

FIG. 5 is a diagram illustrating a configuration of an OLT 20a in an optical transmission system 100a in the second embodiment.

The optical transmission system 100a includes a plurality of ONUS 10-1 to 10-3, the OLT 20a, and an optical splitter 30. In the second embodiment, since the configuration of the OLT 20a is different from the first embodiment, only the OLT 20a will be described.

When allocating a set of a wavelength to be received and a code for decoding to the OLT 20a, the allocation unit 22 allocates the wavelength, a code (the first code, or a code to be allocated to a first decoding unit) corresponding to the wavelength, and a code (the second code, or a code to be allocated to a second decoding unit) allocated to the ONU 10 to which a wavelength that is highly likely to leak is allocated, to a channel corresponding to the wavelength.

The OLT 20a performs processing similar to that of the first embodiment regarding processing from allocation of other wavelengths and codes to decoding. The OLT 20a is different from the first embodiment in processing after decoding, and that the signal for each wavelength is decoded even in the decoding unit 24 for a code corresponding to a wavelength that may leak.

The OLT 20a includes a multiplexer/demultiplexer 21a, an allocation unit 22, a recording unit 23, a plurality of decoding units 24-0 to 24-4, a plurality of splitters 25-1 to 25-3, a plurality of optical reception units 3-1 to 3-3, and a plurality of electrical signal processing units 26-1 to 26-3.

Note that, in the present embodiment, from the viewpoint of reducing the influence of leakage, codes allocated to channels having a high possibility of leakage are more desirably codes having high orthogonality, and from a viewpoint of promptly detecting the presence of leakage from other channels, particularly from an adjacent channel, and instructing drift correction to a channel that has caused leakage, it is desirable to use codes in which leakage is easily detected and erroneous detection is small.

It is desirable to maintain orthogonality and detectability between codes applied to each channel depending on a range in which drift is considered to occur. For example, if a drift width is less than twice a channel interval, the range is at least for adjacent channels, if the drift width is for five channels, the range is for four channels in a direction of drift, and if the drift occurs equally for both sides, the range is for two channels on the short wavelength side and two channels on the long wavelength side. FIG. 5 illustrates an example of one channel adjacent to each of both sides, two channels in total.

The multiplexer/demultiplexer 21a demultiplexes an input optical signal at a wavelength for each ONU 10, that is, for each channel. Optical signals demultiplexed by the multiplexer/demultiplexer 21 are input to the splitters 25-1 to 25-3. The optical signal output from an output for the channel 1 of the multiplexer/demultiplexer 21a is input to the splitter 25-1. The optical signal output from an output for the channel 2 of the multiplexer/demultiplexer 21a is input to the splitter 25-2. The optical signal output from an output for the channel 3 of the multiplexer/demultiplexer 21a is input to the splitter 25-3.

The decoding unit 24-0 to 24-4 decodes the input optical signal by performing decoding with the allocated code and the code corresponding to the wavelength that may be leaked for each wavelength allocated to a corresponding one of the ONUS 10 on the basis of information on the wavelength and the code recorded in the recording unit 23, and detects the presence or absence of the leaking optical signal. In the newly added decoding units 24-0 and 24-4, branch numbers 0 and 4 mean channels on the short wavelength side or the long wavelength side. Note that, in a case where the multiplexer/demultiplexer 21a has a loop property and rotates in three channels, 0 may mean 3, and 4 may mean 1.

The splitters 25-1 to 25-3 distribute optical signals between the multiplexer/demultiplexer 21a and the decoding units 24. The splitter 25-1 is connected to the decoding unit 24-1 as the first decoding unit and the decoding units 24-0 and 24-2 as the second decoding units, the splitter 25-2 is connected to the decoding unit 24-2 as the first decoding unit and the decoding units 24-1 and 24-3 as the second decoding units, and the splitter 25-3 is connected to the decoding unit 24-3 as the first decoding unit and the decoding units 24-2 and 24-4 as the second decoding units. Hereinafter, the decoding units 24-0 to 24-2 connected to the splitter 25-1 are set as a first decoding group G1, the decoding units 24-1 to 24-3 connected to the splitter 25-2 are set as a second decoding group G2, and the decoding units 24-2 to 24-4 connected to the splitter 25-3 are set as a third decoding group G3.

The first decoding group G1 is a group that optically decodes the optical signal output from the output for the channel 1. The first decoding group G1 includes decoding units (decoding units 24-0 and 24-2) for λ0 and which are wavelengths adjacent to the wavelength λ1, to detect leakage of wavelengths adjacent to the wavelength

The decoding unit 24-0 belonging to the first decoding group G1 acquires the code (for example, information on the 0th code) associated with the ONU 10-0 recorded in the recording unit 23. The decoding unit 24-0, or the set of the decoding unit 24-0 and the optical reception unit 3-1, or the set of the decoding unit 24-0, the optical reception unit 3-1, and the electrical signal processing unit 26-1 decodes the input optical signal by decoding the input optical signal with a code on the basis of the acquired information on the code.

In a case where the optical signal of the ONU 10 to which the wavelength λ0 is allocated leaks as the wavelength λ1 into the optical signal having the wavelength λ1 output from the output for the channel 1, the optical signal of the ONU 10 to which the wavelength λ0 of the leakage source is allocated is decoded by the decoding unit 24-0 connected to the splitter 25-1, or a set of the decoding unit 24-0 connected to the splitter 25-1 and the optical reception unit 3-1, or a set of the decoding unit 24-0 connected to the splitter 25-1, the optical reception unit 3-1, and the electrical signal processing unit 26-1, with an output depending on the strength. That is, the number or integration of chips of a predetermined timing, wavelength, polarization, or phase exceeds a predetermined threshold; or a difference between the number or integration of chips of a predetermined timing, wavelength, polarization, or phase and the number or integration of chips of another predetermined timing, wavelength, polarization, or phase exceeds a predetermined threshold; or a result of calculation by the optical reception unit 3 as an output destination exceeds a predetermined threshold, for example, a result of addition/subtraction of an output of a chip of a predetermined timing, wavelength, polarization, or phase input to one input of the differential detector as the optical reception unit 3, and an output of another predetermined timing, wavelength, polarization, or phase input to the other input of the differential detector, exceeds a predetermined threshold. From an output after decoding of another ONU 10 or channel, a significant signal, a preamble, a clock, and the like are extracted directly or as a result of sampling, averaging, or integration.

Note that the threshold value may be adaptively changed or fixed depending on a value and signal strength of a signal to be originally received by the ONU 10. In the fixed case, if sensitivity is emphasized, the output in a case where the signal strength is minimum at the value of the signal originally received by the ONU 10 in which the output of the decoding result with another code is small is used as a reference, and if erroneous detection is to be avoided, the output in a case where the signal strength is maximum at the value of the signal originally received by the ONU 10 in which the output of the decoding result with another code is large is used as a reference, and a noise component only needs to be appropriately considered.

From a viewpoint of improving detection sensitivity, it is desirable to perform detection by performing integration depending on repetition. The repetition is, for example, a cycle depending on a bit rate, a baud rate, a symbol rate, a generator polynomial of a churn or a scrambler, or the like of a signal that may leak. In a case where the cycle is known or assumed in advance, it is desirable to perform integration with the known or assumed cycle. The integration may be performed by the electrical signal processing unit. In consideration of an influence of the phase of the signal, one bit time, one baud time, or one symbol time may be divided into a plurality of times and the integration may be performed, or detection may be performed by performing phase shift and integration in the one bit time, the one baud time, or the one-symbol time.

On the other hand, in a case where the optical signal of the ONU 10 to which the wavelength λ0 is allocated does not leak as the wavelength λ1 into the optical signal having the wavelength λ1 output from the output for the channel 1, the optical signal of the ONU 10 to which the wavelength λ0 of the leakage source is allocated is not significantly decoded by the decoding unit 24-0 connected to the splitter 25-1, or a set of the decoding unit 24-0 connected to the splitter 25-1 and the optical reception unit 3-1, or a set of the decoding unit 24-0 connected to the splitter 25-1, the optical reception unit 3-1, and the electrical signal processing unit 26-1, with an output depending on the strength. That is, the number or integration of chips of a predetermined timing, wavelength, polarization, or phase does not exceed a predetermined threshold; or a difference between the number or integration of chips of a predetermined timing, wavelength, polarization, or phase and the number or integration of chips of another predetermined timing, wavelength, polarization, or phase does not exceed a predetermined threshold; or a result of calculation by the optical reception unit 3 as an output destination does not exceed a predetermined threshold, for example, a result of addition/subtraction of an output of a chip of a predetermined timing, wavelength, polarization, or phase input to one input of the differential detector as the optical reception unit 3, and an output of another predetermined timing, wavelength, polarization, or phase input to the other input of the differential detector, does not exceed a predetermined threshold. Processing similar to that described above is performed in the other decoding units 24-1 and 24-2 of the first decoding group G1, and the second and third decoding groups G2 and G3.

The optical reception units 3-1 to 3-3 have functions similar to those of the first embodiment. The optical reception units 3-1 to 3-3 convert the received optical signals into electrical signals and output the electrical signals to the electrical signal processing units 26-1 to 26-3. For example, detectors for the connected decoding units 24 are provided inside the optical reception units 3-1 to 3-3, and convert the optical signals output from the respective decoding units 24 into electrical signals. For that reason, in a case where an optical signal is input from the port connected to the decoding unit 24-0, the optical reception unit 3-1 converts the input optical signal into an electrical signal and outputs the electrical signal to the electrical signal processing unit 26-1.

The electrical signal processing units 26-1 to 26-3 process the electrical signals converted by the optical reception units 3-1 to 3-3. Specifically, the electrical signal processing units 26-1 to 26-3 detect the presence or absence of an optical signal of another channel, for example, an optical signal from a channel to which an adjacent wavelength is allocated, the optical signal causing wavelength drift and leaking into the wavelength of a host channel, by detecting a signal of a code allocated to the other channel on the basis of the electrical signal. For example, when detecting a significant signal corresponding to a code of another ONU 10, the electrical signal processing units 26-1 to 26-3 detect presence of leakage due to the drift of the optical signal from the ONU 10 detected.

Although an example has been described in which the detection is performed by the electrical signal processing unit 26, in the case of a configuration in which decoding can be performed by the optical reception unit 3, a significant signal of another ONU 10 may be performed on the basis of the presence or absence of an output in the decoding unit 24 depending on a leakage source channel in the optical reception unit 3. In addition, the OLT 20a may perform notification to a processing unit, a transmission unit, or an ONU 10 of a channel from which leakage has occurred, from a channel described later to which leakage has occurred.

The optical reception unit 3-1 and the electrical signal processing unit 26-1 are connected to the first decoding group G1. The optical reception unit 3-2 and the electrical signal processing unit 26-2 are connected to the second decoding group G2. The optical reception unit 3-3 and the electrical signal processing unit 26-3 are connected to the third decoding group G3.

When detecting that there is the drift, the electrical signal processing units 26-1 to 26-3 may perform notification of an instruction to restore the wavelength drift, to the ONU 10 (hereinafter, it is referred to as a “notification target ONU 10”.) that has transmitted the transmission data at the wavelength that has drifted directly or via the electrical signal processing unit 26 corresponding to the ONU 10. In the case of a communication device such as the same OLT 20a communicating with the ONU 10 having the wavelength drift, the OLT 20a notifies the ONU 10. Although a transmitter for communicating with the ONU 10 is not illustrated on the OLT 20a side in FIG. 5, the electrical signal processing unit 26 causes the transmitter to perform notification of the instruction. In a case where the electrical signal processing unit 26 is shared between channels, processing is performed in the electrical signal processing unit 26; however, in the case of channels using separate electrical signal processing units 26, communication is performed for that, and the notification of the instruction is performed. In a case were detection is performed by a communication device not communicating with the ONU 10 having the wavelength drift, a communication device such as the communicating OLT 20a is caused to perform notification of the instruction.

For the instruction of notification, for example, the electrical signal processing units 26-1 to 26-3 may set an instruction of wavelength setting for the corresponding ONU 10 and use the instruction, or may divert exchange with the existing ONU 10. For example, an instruction such as restart, deletion of an authentication state, or reconnection may be used instead. When the influence of the drift is significant, it is desirable to instruct the ONU 10 to temporarily stop the transmission. In addition, an instruction may be given in a form of prompting resetting, restarting, or reconnection on the ONU 10 side, by performing a notification of communication quality degradation such as SD before an error rate of an uplink signal increases, reducing the signal strength of a downlink signal, increasing the error rate, or suppressing signal transmission to a device on the upstream side.

From a viewpoint of suppressing an influence on the notification target ONU 10, when detecting that there is the drift, the electrical signal processing units 26-1 to 26-3 may perform notification to increase the signal strength of the uplink signal of a leakage destination channel, or may decrease the signal strength of the uplink signal of the ONU 10 of a leakage source channel, or may stop transmission, restart, or remove registration.

Further, the electrical signal processing units 26-1 to 26-3 perform signal processing not to transmit a signal decoded with a code associated with another ONU 10 to a higher-level device. For example, it is desirable that the electrical signal processing units 26-1 to 26-3 reduce the signal decoded with the code associated with the other ONU 10 not to transmit the signal as a signal from the unintended ONU 10 to the higher-level device. In the case of transmission to the higher-level device, it is desirable to perform transmission as a signal from the ONU 10 that is the leakage source. The former is suitable for giving a trigger to solve the wavelength drift to the ONU 10 that is the leakage source, and the latter is suitable for continuing communication even in a situation where a signal from the ONU 10 that is the leakage source drifts to a wavelength allocated to another ONU 10.

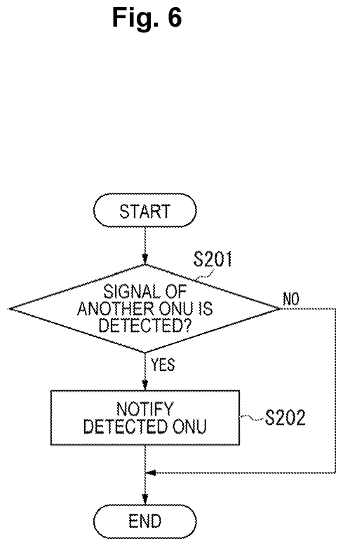

FIG. 6 is a flowchart illustrating a flow of processing of the OLT 20a in the second embodiment. The processing of FIG. 6 is executed after reception processing is performed by the optical reception units 3-1 to 3-3.

The electrical signal processing units 26-1 to 26-3 determine whether or not a signal of another ONU 10 is detected on the basis of the electrical signals output from the optical reception units 3-1 to 3-3 (step S201). In a case where all the electrical signal processing units 26-1 to 26-3 do not detect the signal of the other ONU 10 (step S201: NO), the OLT 20a ends the processing of FIG. 6.

On the other hand, in a case where the signal of the other ONU 10 is detected (YES in step S201), the electrical signal processing unit 26 that detects the signal of the other ONU 10 notifies the notification target ONU 10 (step S202).

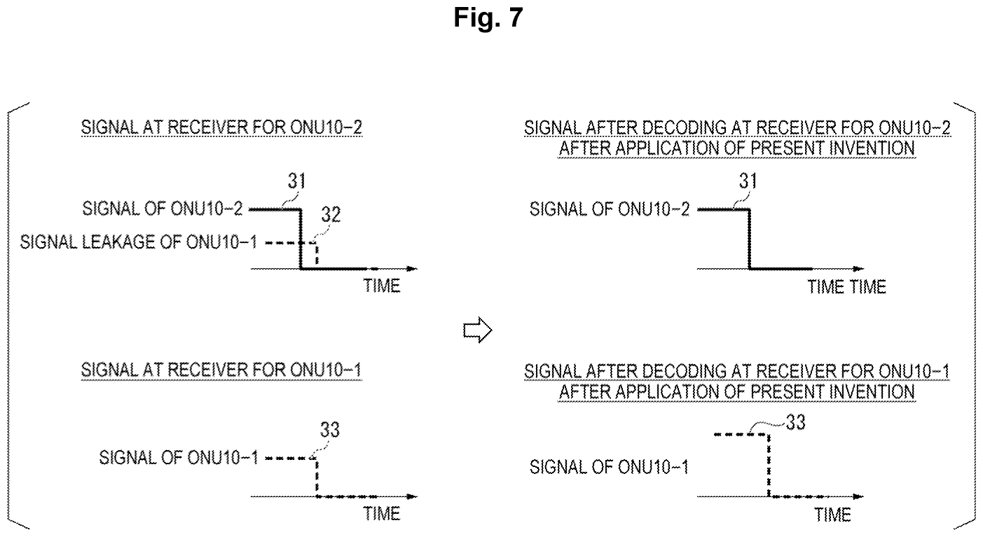

FIG. 7 is a diagram for explaining states of signals of a leakage destination and a leakage source due to leakage in the second embodiment. FIG. 7 illustrates a situation in which the signal strength of the channel from which leakage has occurred decreases in the channel to which leakage has occurred, and increases at the leakage source. An upper left diagram in FIG. 7 illustrates a state of a signal in the receiver for the ONU 10-2 (in the example of FIG. 5, the optical reception unit 3-2) before the processing according to the present invention is applied, and a lower left diagram in FIG. 7 illustrates a state of a signal in the receiver for the ONU 10-1 (in the example of FIG. 5, the optical reception unit 3-1) before the processing according to the present invention is applied. An upper right diagram in FIG. 7 illustrates a state of a signal in the receiver for the ONU 10-2 after the processing according to the present invention is applied, and a lower right diagram in FIG. 7 illustrates a state of a signal in the receiver for the ONU 10-1 after the processing according to the present invention is applied.

In the upper left diagram in FIG. 7, a leakage 32 of the signal of the ONU 10-1 is illustrated in a signal 31 of the ONU 10-2 received by the receiver for the ONU 10-2. That is, a situation is illustrated in which the leakage 32 of another wavelength (for example, λ1) occurs in the signal 31 of the wavelength λ2 of the ONU 10-2. The upper right diagram in FIG. 7 illustrates a situation in which the leakage 32 is resolved by the notification. The lower right diagram in FIG. 7 illustrates a situation in which the signal strength of the ONU 10-1 is increased. This is because the OLT 20a notifies the ONU 10 to which the leaking wavelength is allocated, and the notification target ONU 10 corrects the wavelength deviation, whereby the leakage is resolved.

According to the optical transmission system 100a configured as described above, the multiplexer/demultiplexer 21a is connected to a decoding group including at least the decoding unit 24 (first decoding unit) that decodes a signal of a wavelength depending on an output of the multiplexer/demultiplexer 21a, and the decoding unit 24 (second decoding unit) that decodes a code of the ONU 10 using, for example, an adjacent wavelength that may leak, and the electrical signal processing unit 26 is included that detects presence or absence of leakage on the basis of a decoding result of the decoding unit that decodes the code of the ONU 10 using the adjacent wavelength, for example. When detecting the signal to which leakage has occurred, the electrical signal processing unit 26 notifies the notification target ONU 10 among the plurality of ONUS 10 directly or via another electrical signal processing unit 26f. As a result, signal leakage can be detected, and the wavelength of the channel from which leakage has occurred is also normalized, whereby signal degradation of the channel is reduced. As a result, the influence of the wavelength deviation can be suppressed.

Further, the optical transmission system 100a performs signal processing not to transfer the leaking signal to a higher-level device. As a result, it is possible to prevent an unnecessary signal from being transferred to the higher-level device as a signal of an ONU 10 or a channel different from the original one.

A modification of the second embodiment will be described.

As the OLT 20a in the second embodiment, a configuration has been described in which the multiplexed signal is demultiplexed for each wavelength by the multiplexer/demultiplexer 21. The OLT 20a may include a coupler/splitter before the splitters 25-1 to 25-3 instead of the multiplexer/demultiplexer 21, and may include a filter that transmits a specific wavelength either before or after the splitters 25-1 to 25-3. In the case of being included at the preceding stage, it is preferable from a viewpoint of the number of components with a single wavelength. In the case of being included at the subsequent stage, it is suitable in a case where the wavelength to be filtered is adjusted depending on the code or the decoder.

Although a configuration has been described in which the OLT 20a in the second embodiment includes a plurality of decoding groups, the OLT 20a may include one decoding group. For example, the OLT 20a may include the first decoding group G1. In the case of such a configuration, the OLT 20a includes the allocation unit 22, the recording unit 23, the splitter 25-1, the decoding units 24-0 to 24-2 belonging to the first decoding group G1, a demultiplexer or three filters, the optical reception unit 3-1, and the electrical signal processing unit 26-1. The demultiplexer or the three filters are provided at the preceding stage of the decoding units 24-0 to 24-2. Then, the OLT 20a distributes the multiplexed signal received via the transmission line by the splitter 25-1. The multiplexed signal distributed by the splitter 25-1 is input to the decoding units 24-0 to 24-2 via the filters. The decoding unit 24-1 decodes an optical signal by decoding the demultiplexed optical signal with a code associated with the ONU 10-1, and the decoding units 24-0 and 24-2 detect leakage by decoding extracted optical signals with codes different from the code associated with the ONU 10-1. Note that the splitter 25-1 and the filter may be a multiplexer/demultiplexer, and in a case where the multiplexer/demultiplexer is provided at the preceding stage of the splitter 25-1, it is sufficient that the number of filters is one.

In the OLT 20a in the second embodiment, the optical reception units 3-1 to 3-3 may be configured to output a part of the output from the decoding unit 24 to the adjacent electrical signal processing units 26-1 to 26-3. The first decoding group G1 will be described as an example. Although the decoding units 24-0 to 24-2 are included in the first decoding group G1, for example, the optical signal decoded by the decoding unit 24-2 connected to the splitter 25-1 is an optical signal caused to leak into the wavelength λ1 by the notification target ONU 10, in which the ONU 10 to which the adjacent wavelength is allocated causes wavelength drift and becomes the notification target ONU 10 for the first decoding group G1. Thus, the optical reception unit 3-1 converts the optical signal output from the decoding unit 24-2 into an electrical signal, and outputs the electrical signal to the electrical signal processing unit 26-2 that receives the optical signal of the ONU 10 to which the adjacent wavelength is allocated. Then, the electrical signal processing unit 26-2 notifies the notification target ONU 10 in a case where the electrical signal is input from the adjacent optical reception unit 3.

### Third Embodiment

In the third embodiment, the OLT detects an output of a channel from which leakage has occurred in a leakage destination channel to which leakage has occurred, and adds the detected output to an output of a leakage source channel from which leakage has occurred, to complement a signal of the leakage source channel.

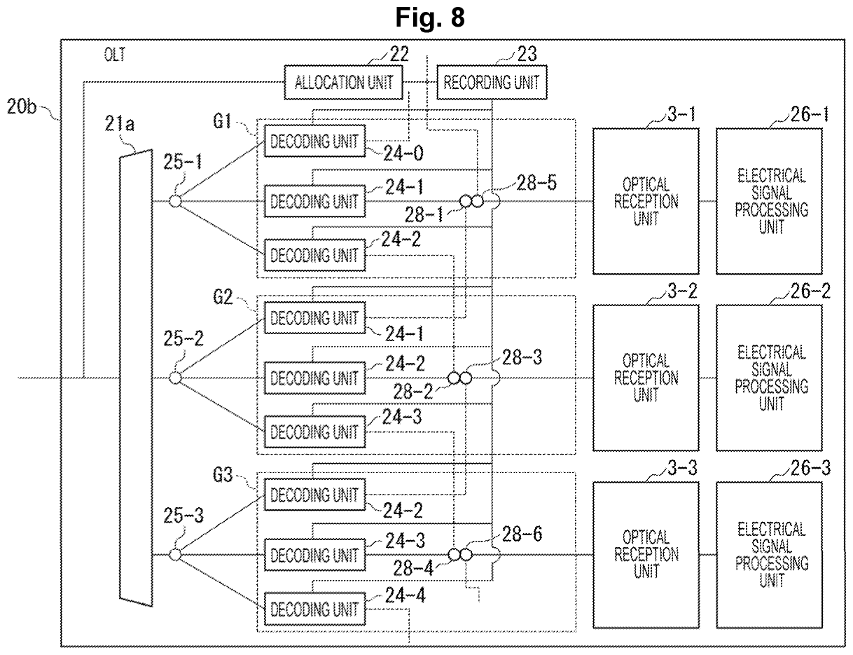

FIG. 8 is a diagram illustrating a configuration of an OLT 20b in an optical transmission system 100b in the third embodiment.

The optical transmission system 100b includes a plurality of ONUS 10-1 to 10-3, the OLT 20b, and an optical splitter 30. In the third embodiment, since the configuration of the OLT 20b is different from the second embodiment, only the OLT 20b will be described.

The OLT 20b performs processing similar to that of the second embodiment regarding processing from allocation of the wavelengths and the codes to decoding. The OLT 20b is different from the second embodiment in processing after decoding.

The OLT 20b includes a multiplexer/demultiplexer 21a, an allocation unit 22, a recording unit 23, a plurality of decoding units 24-0 to 24-4, a plurality of splitters 25-1 to 25-3, a plurality of optical reception units 3-1 to 3-3, a plurality of electrical signal processing units 26-1 to 26-3, and a plurality of addition units 28-1 to 28-6. Hereinafter, differences from the second embodiment will be described.

The decoding units 24-0 to 24-4 perform processing similar to that of functional units having the same names in the second embodiment. Further, the decoding units 24-0 to 24-4 output the optical signals decoded with the codes allocated to the ONUS 10 of the adjacent wavelengths to the addition units 28 provided in paths that output the optical signals of the ONUS 10.

The addition units 28-1 to 28-6 add the optical signals output from the decoding units 24.

Next, processing of the optical transmission system 100b in the third embodiment will be specifically described. In the first decoding group G1, the decoding unit 24-1 (first decoding unit) decodes the optical signal having the wavelength λ1 with the code allocated to the ONU 10 of the wavelength, and the decoding units 24-0 and 24-2 (second decoding units) also perform decoding with the codes corresponding to the ONU 10 of the wavelengths that may leak, for example, the wavelengths λ0 and λ2 as the adjacent wavelengths. The code corresponding to the ONU 10 of the wavelength λ2 is a code corresponding to the ONU 10 of the adjacent wavelength in the first decoding group G1, but is a code corresponding to the ONU 10 to be originally decoded in the second decoding group G2. Thus, the decoding unit 24-2 of the first decoding group G1 connected to the splitter 25-1 outputs the decoded optical signal to the addition unit 28-2 provided on the output path of the decoding unit 24-2 of the second decoding group G2 connected to the splitter 25-2.

Although exemplification has been made with addition of the output of the decoding unit 24-1 of the first decoding group G1 connected to the splitter 25-1 to the output of the decoding unit 24-1 of the second decoding group G2 connected to the splitter 25-2, if there is a 0th decoding group G0 connected to the splitter 25-0 (not illustrated), addition of the output of the decoding unit 24-0 of the first decoding group G1 connected to the splitter 25-1 to the decoding unit 24-0 of the 0th decoding group G0 connected to the splitter 25-0 is similar. In a case where the multiplexer/demultiplexer 21a is of the loop type and the splitter 25-3 corresponds to the splitter 25-0, addition of the output of the decoding unit 24-0 of the first decoding group G1 connected to the splitter 25-1 to the output of the decoding unit 24-3 of the third decoding group G3 connected to the splitter 25-3 is similar.

Note that, in the third embodiment, processing for performing addition in the form of an optical signal is required. At the time of addition, it is necessary to reduce beat noise between optical signals as long as the optical signal is not amplified spontaneous emission (ASE) light. From that viewpoint, it is desirable to perform any one of the following (1) to (3).

(1) A phase of a light beam in a path from demultiplexing by the multiplexer/demultiplexer 21a to multiplexing by the addition unit 28 is adjusted so that phases of multiplexed optical signals are aligned. This is suitable for a case of using a code for encoding or decoding in the phase of light. Usually, a propagation path is provided in which phases of signals accompanying propagation are aligned, and a phase adjustment unit and a phase compensator are provided that compensate for a change in phase difference of light accompanying a temperature change or the like. In the adjustment of the phase of the light, it is desirable to align the absolute phase in addition to the relative phase, and from a viewpoint of setting the shift of the phase of the signal to be less than the bit time, the baud time, or one symbol time, for example, it is desirable to be sufficiently smaller than half of the time. The upper limit of the tolerance of the signal phase shift is determined depending on whether it contributes to the restoration of the signal leaked by the addition or becomes noise. The tolerance of the signal phase shift is similar.

(2) Multiplexing is performed by polarization multiplexing. This is suitable in a case where the optical signal is linearly polarized. Considering that leakage is usually at a wavelength of one of the long wavelength side or the short wavelength side, a signal from a leakage destination channel is multiplexed to be a polarized wave orthogonal to a polarized wave of a leakage source channel. Thus, polarized waves of signals multiplexed from leakage destination channels are multiplexed with the same polarization. From a viewpoint of multiplexing with orthogonal polarization, it is desirable that, in a path from demultiplexing by the multiplexer/demultiplexer 21a to multiplexing by the addition unit 28, there is no place where polarized waves rotate except for a polarizer or the like for forming orthogonally polarized waves at the time of multiplexing, or polarization is maintained. In a case where the polarization is maintained in the transmission line between the ONU 10 and the OLT 20b, the latter is preferable, but otherwise, the former is suitable since the polarization at the time of input to the multiplexer/demultiplexer 21a is unknown.

(3) Depolarization is performed by a depolarizer and multiplexing is performed. In this case, beat noise can be reduced as compared with a case where polarized waves are aligned. Thus, for example, the OLT 20b includes a phase adjustment unit (not illustrated) that performs adjustment so that the phases of an addition signal and a signal to be added are synchronized with each other, on a path up to addition of the optical signal. In the above example, the addition signal is an optical signal demultiplexed as the wavelength λ1 decoded with the code corresponding to the wavelength λ2 in the first decoding group G1, and the signal to be added is an optical signal demultiplexed as the wavelength λ2 decoded with the code corresponding to the wavelength λ2 in the second decoding group G2. The phase adjustment unit may be provided on any path as long as the path is after demultiplexing and before adding the addition signal and the signal to be added together. Hereinafter, the same applies to other decoding groups.

In the above, although a configuration has been described in which the leaking optical signal is added to the optical signal of the leakage source as it is, the result received by the optical reception unit 3 may be added. In particular, it is suitable for a code to be decoded by detecting a plurality of outputs from the decoding units 24 by the plurality of optical reception units and performing addition/subtraction. In this case, it is sufficient that the outputs on the addition side and the outputs on the subtraction side are detected, all the outputs on the addition side are added, and all the outputs on the subtraction side are subtracted.

The processing similar to that as described above is performed in the second and third decoding groups G2 and G3, and thus the description thereof will be omitted.

Although not illustrated in FIG. 8 for simplification of description, in a case where the output for the channel 4 is in the multiplexer/demultiplexer 21a, there is a fourth decoding group G4 as a group for decoding the optical signal that is the output for the channel 4 output from the multiplexer/demultiplexer 21a. In this case, the optical signal having the wavelength λ4 decoded by the decoding unit 24-4 belonging to the third decoding group G3 is output to the addition unit 28 provided on the output path of the decoding unit 24-4 of the fourth decoding group G4. In addition, the optical signal having the wavelength λ3 decoded by the decoding unit 24-3 belonging to the fourth decoding group G4 is output to the addition unit 28-6 provided on the output path of the decoding unit 24-3 of the third decoding group G3.

With the above processing, the addition unit 28-1 adds together the optical signal output from the decoding unit 24-1 belonging to the first decoding group G1 and the optical signal output from the decoding unit 24-1 belonging to the second decoding group G2. The addition units 28-2 to 28-6 also performs addition of the optical signals output from the respective plurality of decoding units 24 connected by the solid line or the dotted line illustrated in FIG. 8.

However, in a case where a beat between transmission wavelengths of the ONUS 10 is superimposed on signals and does not contribute to signal-noise (SN) improvement, it is desirable to have a mechanism for switching not to perform addition.

Here, the output decoded with the code of the leakage source from which leakage has occurred in the leakage destination channel to which leakage has occurred is used to compensate for signal degradation of the leakage source channel.

As a modification, it may be used for removal of an influence due to leakage on the leakage destination channel to which leakage has occurred. That is, the output of the leakage source channel from which leakage has occurred in the leakage destination channel to which leakage has occurred is detected, and the detected output is added to the output of the leakage source channel from which leakage has occurred, and subtracted from the output of the leakage destination channel to which leakage has occurred similarly to the fourth embodiment described later, whereby the signal of the leakage destination channel may be improved. Here, to split the output, it is desirable to perform proportional distribution or amplify the split output. In addition, regarding the subtraction, for example, in the case of a code to be decoded only by the decoding unit 24, an optical signal that cancels the leakage signal is generated and added. Specifically, an optical signal having the same optical frequency and polarization but having an inverted phase is added at a timing at which the phase is reversed. Such an optical signal is formed by performing conversion in a predetermined phase relationship using, for example, a non-linear optical effect or the like so that the phase is inverted when the optical signal is restored to the original wavelength.

In the case of a code to be decoded by performing addition/subtraction of a plurality of detection results by a set of the decoding unit 24 and the optical reception unit 3 or the like, subtraction may be performed by addition to the output of the decoding unit 24 output to the subtraction side, or optical reception may be separately performed and the result may be subtracted. In a case where the strength of the leakage signal is multiplied by a coefficient and subtracted, the latter is desirable. This assumes, for example, that both the leakage source and leakage destination signals are improved by the addition of optical signals. In this case, the original signal needs to be divided, and its strength decreases. For that reason, the signal is amplified at the optical stage and then divided, or amplified at the electrical stage. It is easier to amplify the signal at the electrical stage, and the signal is received and split at the electrical stage, amplified (for example, 4 times when it becomes ¼ in division) to match the original strength, and used for addition of the signal of the leakage source and subtraction of the signal of the leakage destination. In this case, it is sufficient that optical detection is performed on each of the addition side and the subtraction side, and both values are added/subtracted and used for the leakage source, and both values are used for the subtraction at the leakage destination.

Note that, as a further modification, the signal received by the second decoding unit that is the leakage destination may be used to improve the signal of the leakage destination. That is, the output of the leakage source channel from which leakage has occurred in the leakage destination channel to which leakage has occurred is detected, and instead of adding the detected output to the output of the leakage source channel from which leakage has occurred, the detected output may be subtracted from the output of the leakage destination channel to which leakage has occurred similarly to the fourth embodiment described later. In this case, although the signal of the leakage source is not improved, there is an effect of reducing signal degradation at the leakage destination. This configuration is similar to, but different from, the fourth embodiment using a duplicate of the signal of the leakage source since the signal to which leakage has occurred is used to improve the signal on the side to which leakage has occurred, and in a case where it is used in combination with the duplicate in the fourth embodiment, it is necessary to perform proportional distribution so that the effect is equal to the influence of the leaking signal not to reduce the influence of leakage excessively. In calculation of addition/subtraction, addition is performed so that the phases of the signals are aligned, for example, with accuracy less than or equal to half the time corresponding to one bit, one baud, or one symbol.

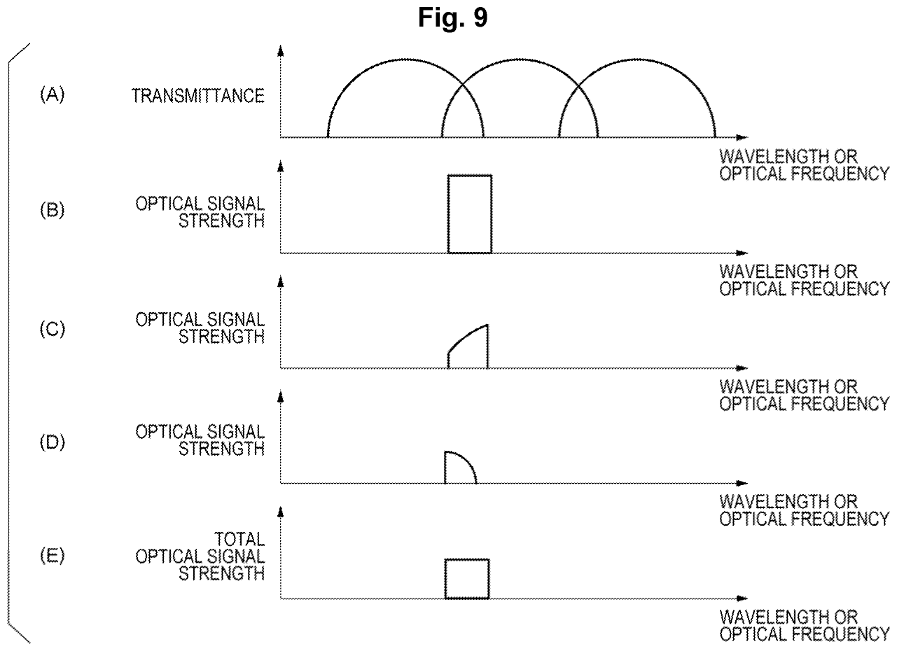

FIG. 9 is a diagram illustrating an example of demultiplexing characteristics and light transmission of the multiplexer/demultiplexer 21a in the third embodiment. The multiplexer/demultiplexer 21a that performs demultiplexing for each wavelength preferably has large crosstalk as illustrated in FIG. 9. This is because if the crosstalk is small, a deviating component is lost in the multiplexer/demultiplexer 21a, and an amount that cannot be added increases.

In FIG. 9(A), the horizontal axis represents the wavelength or the optical frequency, and the vertical axis represents the transmittance. Each peak illustrated in FIG. 9(A) indicates a transmission characteristic of each channel. As illustrated in FIG. 9(A), the transmission wavelengths of the adjacent channels partially overlap each other. Note that the total of the transmittances of all channels with respect to the wavelength does not exceed 1 unless amplification is performed before measurement at, for example, the time of demultiplexing or before or after the demultiplexing.

FIG. 9(B) is a diagram illustrating an input example of an optical signal to which a wavelength of a certain channel, for example, a center channel is allocated and that has drifted to the left side. In FIG. 9(B), the horizontal axis represents the wavelength or the optical frequency, and the vertical axis represents the optical signal strength of a certain channel input to the multiplexer/demultiplexer 21a.

FIGS. 9(C) and 9(D) are diagrams illustrating examples of outputs from channels. In FIG. 9(C), the horizontal axis represents the wavelength or the optical frequency, and the vertical axis represents the optical signal strength demultiplexed to the center channel. In FIG. 9(D), the horizontal axis represents the wavelength or the optical frequency, and the vertical axis represents the optical signal strength demultiplexed to the channel on the left (short wavelength) side. FIG. 9(E) is a diagram illustrating the total optical signal strength of both channels illustrated in FIGS. 9(C) and 9(D). In FIG. 9(E), the horizontal axis represents the wavelength or the optical frequency, and the vertical axis represents the total optical signal strength of both channels.

As illustrated in FIG. 9, since the transmission wavelengths overlap between the channels, leakage into the channel on the left (short wavelength) side cannot be ignored. However, the strength of the optical signal in the center channel is relatively large, and is further increased in terms of the sum of the two. Thus, the channel from which leakage has occurred can complement the signal lost due to the leakage by discriminating and adding the leakage to the adjacent channel.

The characteristics illustrated in FIG. 9 may be used in the second embodiment or an embodiment described later. When the characteristics are used in the second embodiment, there are few wavelength regions that are not transmitted through the multiplexer/demultiplexer at the time of wavelength drift, and thus there is an effect that drift is detected quickly.

Note that the complement of the leakage into the adjacent channel may be limited to a range of the allocated wavelength in FIG. 2A, may be limited to a reception range of the adjacent channel, or may be expanded to the adjacent channel. The expanded range is desirably a range of channels in which at least the allocated wavelengths have different codes, and in the case of using codes in which orthogonality degrades as the allocated wavelengths are farther from each other, is desirably up to a channel to which a code whose orthogonality is in a predetermined range is allocated.

The range may be limited on the basis of implementation of devices such as up to how many channels, or may be limited on the basis of a degree of removal of signal components of other channels. In the latter case, for example, the range is narrowed as the number of drifting channels is larger. The range of tracking to the wavelength drift may be limited to any number of channels by using a multiplexer/demultiplexer having a large crosstalk between adjacent channels, or the reception range may be limited by a digital or analog filter at the electrical stage in a case where the wavelength axis of light is converted onto an electrical frequency axis by coherent detection or the like.

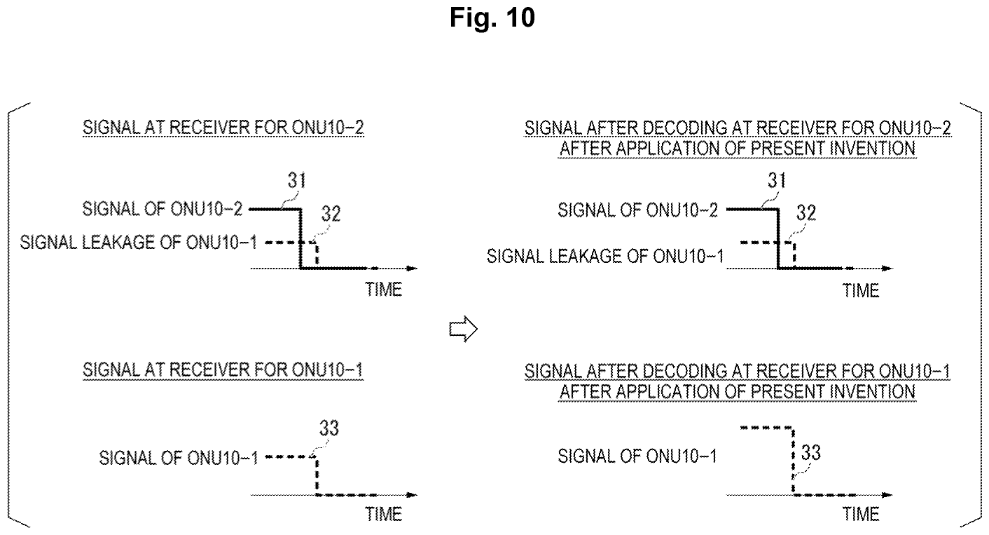

FIG. 10 is a diagram for explaining states of signals of a leakage destination and a leakage source due to leakage in the third embodiment. An upper left diagram in FIG. 10 illustrates a state of a signal in the receiver for the ONU 10-2 (in the example of FIG. 8, the optical reception unit 3-2) before the processing according to the present invention is applied, and a lower left diagram in FIG. 10 illustrates a state of a signal in the receiver for the ONU 10-1 (in the example of FIG. 1, the optical reception unit 3-1) before the processing according to the present invention is applied. An upper right diagram in FIG. 10 illustrates a state of a signal in the receiver for the ONU 10-2 after the processing according to the present invention is applied, and a lower right diagram in FIG. 10 illustrates a state of a signal in the receiver for the ONU 10-1 after the processing according to the present invention is applied.

In the upper left diagram in FIG. 10, a leakage 32 of the signal of the ONU 10-1 is illustrated in a signal 31 of the ONU 10-2 received by the receiver for the ONU 10-2. That is, a situation is illustrated in which the leakage 32 from a channel to which another wavelength (for example, 21) is allocated occurs in the signal 31 of the wavelength λ2 of the ONU 10-2. The upper right diagram in FIG. 10 illustrates a situation in which the leakage 32 does not change. On the other hand, the lower right diagram in FIG. 10 illustrates a situation in which the signal of the leakage source is improved. Here, the figure illustrates a case where the output of the detected leakage is added to the output of the leakage source channel from which leakage has occurred in the present embodiment, and the output of the detected leakage is not subtracted from the output of the leakage destination channel to which leakage has occurred.

According to the optical transmission system 100b configured as described above, the OLT 20b decodes the signal of the leaking wavelength and adds the signal of the wavelength to the output signal of the decoding unit 24 that decodes the signal, to complement the signal that has leaked. As a result, even in a case where the reception light strength is degraded due to the wavelength deviation, it is possible to suppress degradation of the signal quality of the channel in which the wavelength deviation occurs.

A modification of the third embodiment will be described.

The optical transmission system 100b in the third embodiment may be modified similarly to the second embodiment. Similarly to the second embodiment, this modification is easier than processing a phase of light to process a baseband signal after optical detection or a signal of an intermediate frequency after coherent detection such as heterodyne detection, and is also suitable for digital signal processing that is digitized by an ADC or the like and performed by a DSP or the like.

In the third embodiment, it is desirable to output a probable code by using maximum likelihood determination or the like for signal identification. In this configuration, a code of CDM used for mobile radio or the like can be used.

In the third embodiment, a configuration has been described in which the OLT 20b performs optical detection on the optical signals demultiplexed to different wavelengths after adding the outputs of the decoders having the same codes. The OLT 20b may be configured to add the optical signals demultiplexed to different wavelengths together after the optical detection of the output of the decoding unit 24 having the same codes. In the case of such a configuration, the addition units 28-1 to 28-6 are provided on the output side of the optical reception unit 3, for example, in the electrical signal processing units 26-1 to 26-3. Outputs of the respective decoding units 24-0 to 24-4 are input to the optical reception units 3-1 to 3-3 and are subjected to optical detection. Then, the optical reception units 3-1 to 3-3 output the electrical signals converted by the optical detection to the electrical signal processing units 26-1 to 26-3. Thereafter, in the addition units 28-1 to 28-6 provided in the electrical signal processing units 26-1 to 26-3, the electrical signals corresponding to the same code are added together. As a result, in the addition units 28-1 to 28-6, electrical signals corresponding to the same ONU 10 or channel can be added together. In calculation of addition, addition is performed so that the phases of the signals are aligned, for example, with accuracy less than or equal to half the time corresponding to one bit, one baud, or one symbol.

### Fourth Embodiment

In the fourth embodiment, an OLT detects an output of a channel from which leakage has occurred on the channel and the strength of the channel from which leakage has occurred at a channel to which leakage has occurred, subtracts, from an output of the channel to which leakage has occurred, a duplication signal obtained by multiplying the output of the channel from which leakage has occurred by the leakage strength at the channel to which leakage has occurred, and reduces an influence of a signal of the channel from which leakage has occurred from a signal of the channel to which leakage has occurred.

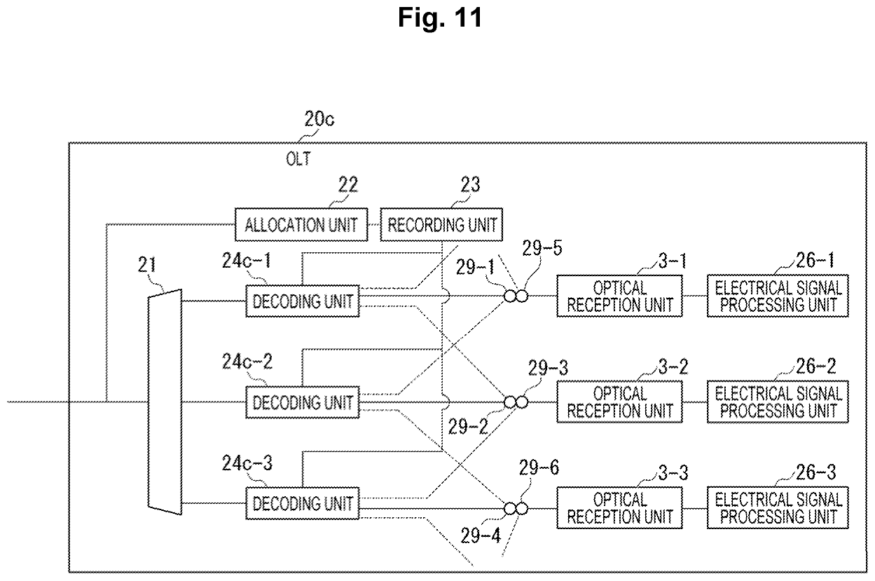

FIG. 11 is a diagram illustrating a configuration of an OLT 20c in an optical transmission system 100c in the fourth embodiment.

The optical transmission system 100c includes a plurality of ONUS 10-1 to 10-3, the OLT 20c, and an optical splitter 30. In the fourth embodiment, since the configuration of the OLT 20c is different from the first embodiment, only the OLT 20c will be described.

The OLT 20c performs processing similar to that of the second embodiment regarding processing from allocation of the wavelengths and the codes to decoding. The OLT 20c is different from the first embodiment in processing after decoding.

The OLT 20c includes a multiplexer/demultiplexer 21, an allocation unit 22, a recording unit 23, a plurality of decoding units 24c-1 to 24c-3, subtraction units 29-1 to 29-6, a plurality of optical reception units 3-1 to 3-3, and a plurality of electrical signal processing units 26-1 to 26-3.

The decoding units 24c-1 to 24c-3 perform processing similar to that of functional units having the same names in the first embodiment. Further, in a case where the signal decoded by the decoding unit 24c leaks into the channel of the adjacent wavelength due to the wavelength drift of the ONU 10, the decoding units 24c-1 to 24c-3 output the signal decoded with the code to the subtraction unit 29 provided in the path for outputting the signal of the ONU of the wavelength that is the leakage destination.

The subtraction units 29-1 to 29-6 subtract the duplication signal of the reception signal of the ONU 10 that is the leakage source from the optical signal output from the decoding unit 24c.

Next, processing of the optical transmission system 100c in the fourth embodiment will be specifically described with an example in which leakage from the decoding unit 24c-1 occurs in the decoding unit 24c-2. The decoding unit 24c-1 that is the leakage source decodes the optical signal having the wavelength λ1. The decoding unit 24c-1 multiplies the decoded optical signal by a coefficient corresponding to leakage to an adjacent wavelength. As a result, a duplication signal is generated. Then, the decoding unit 24c-1 outputs the multiplied optical signal to the subtraction unit 29-2 provided on the output path of the decoding unit 24c-2 that is the leakage destination.

Here, the coefficient may be calculated by the electrical signal processing unit 26f-1 at the leakage source capable of estimating the leakage strength due to a decrease in the signal strength, or may be calculated by the electrical signal processing unit 26f-2 at the leakage destination capable of estimating the leakage strength from an increase in the strength due to the leakage, and multiplication may be performed by either.

The subtraction unit 29-2 at the leakage destination subtracts the duplication signal obtained by multiplying the output of the decoding unit 24c-2 that is the leakage source by the leakage strength from the output of the decoding unit 24c-1 that is the leakage destination to reduce the influence of leakage at the leakage destination.

To subtract the optical signal as it is, the signal of the leakage source is frequency-shifted to match the optical frequency of the leaking optical signal and the shape of the strength with respect to the frequency, and the shape of the strength with respect to the optical frequency and the phase of the light are inverted and added depending on a difference in filtering characteristics of the multiplexer/demultiplexer 21 and the like, whereby the subtraction is performed. As in the latter half of the third embodiment, it is desirable to perform the processing of (1) described above so that the phase of light is inverted but beat fluctuation does not occur when light is multiplexed. Although not illustrated, this optical signal duplication function is arranged on a wavy line connecting the decoding unit 24c and the subtraction unit 29.

In a case where a plurality of outputs of the decoding unit 24c is input to a plurality of ports of the optical reception unit 3, and the reception results are added and subtracted to perform decoding, the plurality of outputs from the decoding unit 24c may be input to an addition/subtraction side depending on a code, for example, a subtraction side in a case of a code to be output to an addition side by an encoder at the leakage destination, and may be multiplied by a coefficient by amplification or attenuation and subtracted. In this case, there is an effect that it is not necessary to create a duplication signal in which the frequency is shifted and the phase is inverted. Similarly to the latter half of the third embodiment, it is desirable to perform the processing of (2) to (3) described above so that addition/subtraction are inverted but beat fluctuation does not occur when light is multiplexed. Alternatively, different optical reception units 3 may perform reception, and the output may be multiplied by a coefficient and subtracted. In this case, there is an effect that light amplification can be avoided. As in the latter half of the third embodiment, the subtraction is desirably performed before identification processing or the like is performed.

Note that the same applies to a case where there is a decoding unit 24c-0 and leakage occurs to the decoding unit 24c-0, and processing of the output of the decoding units 24c-2 and 3 is similar except that the output destination is different from that of the decoding unit 24c-1, and thus, description thereof is omitted.

Although not illustrated in FIG. 11 for simplification of description, in a case where the output for the channel 0 is in the multiplexer/demultiplexer 21, the decoding unit 24c-0 is connected to the output for the channel 0. In this case, the decoding unit 24c-0 outputs the multiplied optical signal to the subtraction unit 29-5 provided on the output path of the decoding unit 24c-1.

Although not illustrated in FIG. 11 for simplification of description, in a case where the output for the channel 4 is in the multiplexer/demultiplexer 21, the decoding unit 24c-4 is connected to the output for the channel 4. In this case, the decoding unit 24c-4 outputs the multiplied optical signal to the subtraction unit 29-6 provided on the output path of the decoding unit 24c-4.

With the above processing, the subtraction unit 29-1 subtracts the optical signal output from the decoding unit 24-2 from the optical signal output from the decoding unit 24c-1. The subtraction units 29-2 to 29-6 also perform subtraction of the optical signals output from the respective plurality of decoding units 24c connected by the solid line or the dotted line illustrated in FIG. 11.

Note that, in a case where the subtraction unit 29 performs subtraction of the optical signal, it is desirable to perform the subtraction before performing 0/1 determination, error correction, restoring descrambling, or hard determination by a discriminator.

In addition, in a case where a beat between transmission wavelengths of the ONUs 10 is superimposed on signals and does not contribute to SN improvement, it is desirable to have a mechanism for switching not to perform subtraction.

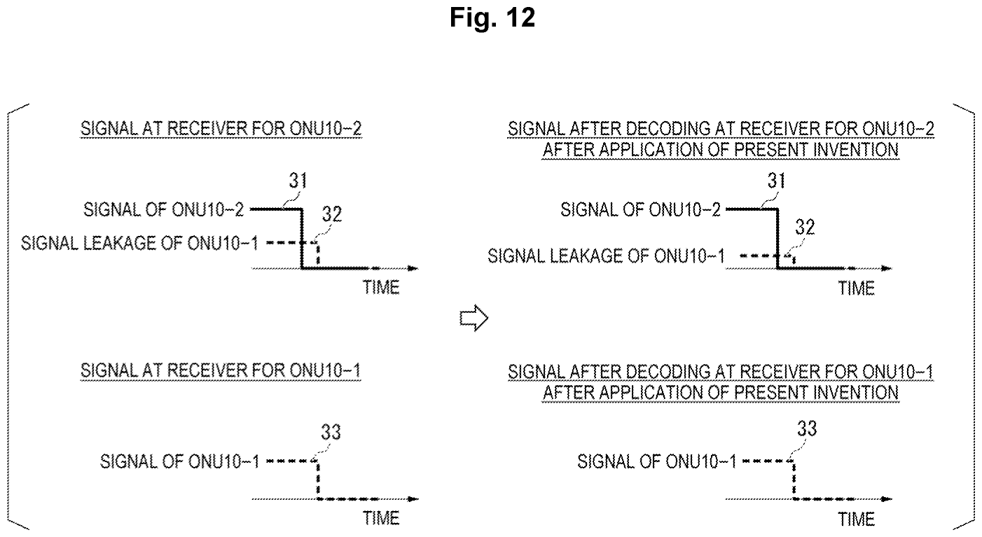

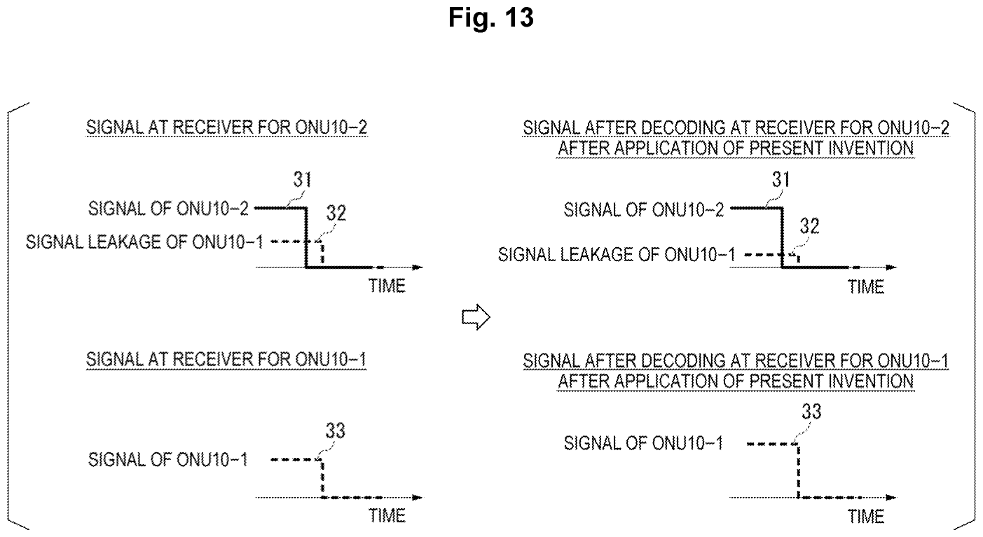

FIG. 12 is a diagram for explaining states of signals of a leakage destination and a leakage source due to leakage in the fourth embodiment. An upper left diagram in FIG. 12 illustrates a state of a signal in the receiver for the ONU 10-2 (in the example of FIG. 11, the optical reception unit 3-2) before the processing according to the present invention is applied, and a lower left diagram in FIG. 12 illustrates a state of a signal in the receiver for the ONU 10-1 (in the example of FIG. 11, the optical reception unit 3-1) before the processing according to the present invention is applied. An upper right diagram in FIG. 13 illustrates a state of a signal in the receiver for the ONU 10-2 after the processing according to the present invention is applied, and a lower right diagram in FIG. 13 illustrates a state of a signal in the receiver for the ONU 10-1 after the processing according to the present invention is applied.

In the upper left diagram in FIG. 13, a leakage 32 of the signal of the ONU 10-1 is illustrated in a signal 31 of the ONU 10-2 received by the receiver for the ONU 10-2. That is, a situation is illustrated in which the leakage 32 of another wavelength (for example, λ1) occurs in the signal 31 of the wavelength λ2 of the ONU 10-2. The upper right diagram in FIG. 13 illustrates a situation in which an influence of the leakage 32 ideally disappears, and is reduced in a normal case. On the other hand, the lower right diagram in FIG. 13 illustrates a situation in which the signal of the leakage source does not change.

According to the optical transmission system 100c configured as described above, the OLT 20c subtracts the signal of the leaking wavelength from the output signal. As a result, the influence on the leakage destination can be reduced.

### Fifth Embodiment

The fifth embodiment is an embodiment in which the third embodiment and the fourth embodiment are combined. Specifically, in an optical transmission system in the fifth embodiment, an OLT detects an output of a channel from which leakage has occurred at a channel to which leakage has occurred, an output of the channel from which leakage has occurred at the channel, and the strength of the channel from which leakage has occurred at the channel to which leakage has occurred. The OLT adds the output of the channel from which leakage has occurred at the channel to which leakage has occurred to the output of the channel from which leakage has occurred to complement an optical signal of the channel from which leakage has occurred, subtracts, from the output of the channel to which leakage has occurred, a duplication signal obtained by multiplying the output of the channel from which leakage has occurred by the leakage strength at the channel to which leakage has occurred, and mitigates an influence of the channel from which leakage has occurred from an optical signal of the channel to which leakage has occurred.

In this case, an OLT 20d in the fifth embodiment includes a multiplexer/demultiplexer 21, an allocation unit 22, a recording unit 23, a plurality of decoding units 24d-1 to 24d-3, a plurality of addition units 28-1 to 28-6, a plurality of subtraction units 29-1 to 29-6, a plurality of optical reception units 3-1 to 3-3, and a plurality of electrical signal processing units 26-1 to 26-3. The functional units, the multiplexer/demultiplexer 21, the allocation unit 22, the recording unit 23, the plurality of decoding units 24d-1 to 24d-3, the plurality of addition units 28-1 to 28-6, the plurality of subtraction units 29-1 to 29-6, the plurality of optical reception units 3-1 to 3-3, and the plurality of electrical signal processing units 26-1 to 26-3, perform basically the same processing as the functional units having the same names in the third embodiment or the fourth embodiment.

Processing of adding the output of the channel from which leakage has occurred at the channel to which leakage has occurred to the output of the channel from which leakage has occurred to complement the optical signal of the channel from which leakage has occurred in the fifth embodiment is similar to that in the third embodiment. In addition, in the fifth embodiment, processing of subtracting, from the output of the channel to which leakage has occurred, the duplication signal obtained by multiplying the output of the channel from which leakage has occurred by the leakage strength at the channel to which leakage has occurred, and mitigating the influence of the channel from which leakage has occurred from the optical signal of the channel to which leakage has occurred is similar to that in the fourth embodiment.

The decoding units 24d-1 to 24d-3 detect the output of the channel from which leakage has occurred (adjacent wavelength) at the channel to which leakage has occurred (wavelength to be decoded), the output of the channel from which leakage has occurred at the channel, and the strength of the channel from which leakage has occurred at the channel to which leakage has occurred. The decoding units 24d-1 to 24d-3 output the output of the channel from which leakage has occurred at the channel to which leakage has occurred to the addition unit 28 provided on the output path of the decoding unit 24d that decodes the optical signal of the wavelength of the channel from which leakage has occurred.

For example, the addition units 28-2 and 28-3 are provided on the output path of the decoding unit 24d-2. The addition unit 28-2 adds together the optical signal decoded by the decoding unit 24d-2 (the output of the channel from which leakage has occurred at the channel) and the optical signal output from the decoding unit 24d-1 (the output of the channel from which leakage has occurred at the channel to which leakage has occurred). The addition unit 28-3 adds together the optical signal added by the addition unit 28-2 and the optical signal output from the decoding unit 24d-3 (the output of the channel from which leakage has occurred at the channel to which leakage has occurred). As a result, the optical signal of the channel from which leakage has occurred is complemented. The same applies to the other decoding units 24d-1 and 24d-3. For example, the addition units 28-1 and 28-5 are provided on the output path of the decoding unit 24d-1. For example, the addition units 28-4 and 28-6 are provided on the output path of the decoding unit 24d-3.

In addition, in a case where leakage occurs in the decoding unit 24d-2 from the decoding unit 24d-1, the decoding unit 24d-1 that is the leakage source decodes the optical signal having the wavelength λ1. The decoding unit 24d-1 multiplies the decoded optical signal by a coefficient corresponding to leakage to an adjacent wavelength. As a result, a duplication signal is generated. Then, the decoding unit 24d-1 outputs the multiplied optical signal to the subtraction unit 29-2 provided on the output path of the decoding unit 24d-2 that is the leakage destination. The subtraction units 29-1 to 29-6 are provided at the subsequent stages of the addition units 28-1 to 28-6. The subtraction unit 29-2 subtracts the optical signal output from the decoding unit 24d-1 (multiplied optical signal) from the optical signal output from the addition unit 28-3.

FIG. 13 is a diagram for explaining states of signals of a leakage destination and a leakage source due to leakage in the fifth embodiment. An upper left diagram in FIG. 13 illustrates a state of a signal in the receiver for the ONU 10-2 (in the example of FIG. 11, the optical reception unit 3-2) before the processing according to the present invention is applied, and a lower left diagram in FIG. 13 illustrates a state of a signal in the receiver for the ONU 10-1 (in the example of FIG. 11, the optical reception unit 3-1) before the processing according to the present invention is applied. An upper right diagram in FIG. 13 illustrates a state of a signal in the receiver for the ONU 10-2 after the processing according to the present invention is applied, and a lower right diagram in FIG. 13 illustrates a state of a signal in the receiver for the ONU 10-1 after the processing according to the present invention is applied.

In the upper left diagram in FIG. 13, a leakage 32 of the signal of the ONU 10-1 is illustrated in a signal 31 of the ONU 10-2 received by the receiver for the ONU 10-2. That is, a situation is illustrated in which the leakage 32 of another wavelength (for example, λ1) occurs in the signal 31 of the wavelength λ2 of the ONU 10-2. The upper right diagram in FIG. 13 illustrates a situation in which the leakage 32 decreases. On the other hand, the lower right diagram in FIG. 13 illustrates a situation in which the signal of the leakage source is improved.

### Sixth Embodiment

The sixth embodiment is different from the first embodiment to the fifth embodiment in a portion that performs decoding. Specifically, while the electrical decoding is performed in the sixth embodiment, the optical decoding is performed in the first embodiment to the fifth embodiment. Hereinafter, details of differences will be described.

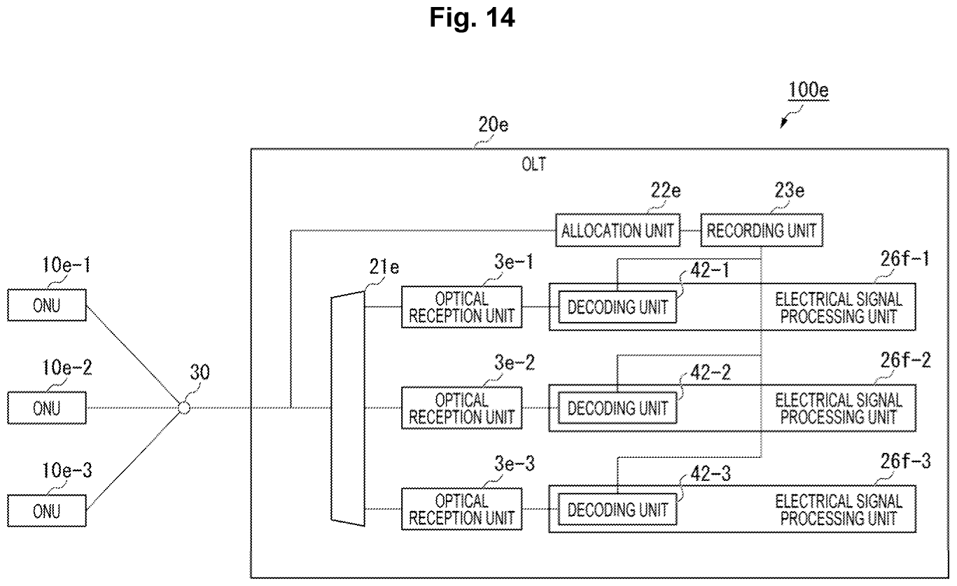

FIG. 14 is a diagram illustrating a system configuration of an optical transmission system 100e in the sixth embodiment. In the following description, as the optical transmission system 100e, as an example, a description will be given of an uplink of a PON that is a 1-to-N network with M as 1 in an M-to-N network for simplification of description.

The optical transmission system 100e includes a plurality of ONUs 10e-1 to 10e-3, an OLT 20e, and an optical splitter 30. The plurality of ONUs 10e-1 to 10e-3 and the OLT 20e are communicably connected to each other via the optical splitter 30. The plurality of ONUs 10e-1 to 10e-3 are connected to the optical splitter 30 by optical fibers, and the OLT 20e is connected to the optical splitter 30 by an optical fiber. In the case of uplink communication from the ONUs 10e to the OLT 20e, the plurality of ONUs 10e corresponds to the optical transmission devices described in (Overview). The OLT 20e corresponds to the optical reception device described in (Overview). In the case of a downlink, the opposite is true.

The ONU 10e is an optical line terminal installed in a customer's home. The ONU 10e performs encoding on the basis of a code allocated from the OLT 20e, and transmits, to the OLT 20e, an optical signal having a wavelength allocated from the OLT 20e. The ONU 10e generates transmission data by performing encoding on the basis of the code allocated from the OLT 20e. For example, the ONU 10e performs electrical encoding on the basis of information on the allocated code, for example, a code of a predetermined value, a generator polynomial and an initial value of a churn or a scrambler. As described above, the ONU 10e includes at least a transmission unit that encodes transmission data on the basis of the allocated code and outputs the transmission data to an optical transmission line at the allocated wavelength. Note that an encoder may include an electrical or optical analog circuit, and the code may also be an optical code.

The OLT 20e is an optical subscriber line terminal installed in an office building. The OLT 20e allocates different wavelengths to the respective ONUs 10e. For example, the OLT 20e allocates adjacent wavelengths between the ONUs 10e as the different wavelengths.

In the following description, it is assumed that the OLT 20e allocates the wavelength λ1 to the ONU 10e-1, allocates the wavelength λ2 to the ONU 10e-2, and allocates the wavelength λ3 to the ONU 10e-3. The OLT 20e allocates, to the ONUs 10e, wavelengths adjacent to those for other ONUs 10e as described above, and in a case where wavelengths that may cause wavelength drift are adjacent wavelengths, the OLT 20e allocates at least different codes between the ONUs 10e to which the adjacent wavelengths are allocated. For example, among the ONUs 10e to which adjacent wavelengths that are wavelengths that may drift are allocated, in the case of churns or scramblers having different codes, the OLT 20e performs allocation so that one or both of a generator polynomial and an initial value of the churns or the scramblers are different from each other.

Note that, in a case where the electrical decoding is performed as in the sixth embodiment, since signal determination and signal addition are performed before 0/1 determination is performed on the decoding side, a decoding unit for performing signal identification for each user's wavelength is arranged before 0/1 determination is performed. Note that, in a case where an optical code or the like is used for signal identification for each ONU 10e, and a churn or a scrambler is not used for signal identification for each ONU 10e, arrangement may be performed after 0/1 determination, or the churn or the scrambler may be provided before 0/1 determination for identification for each ONU 10e and after 0/1 determination for other purpose.

Next, an internal configuration of the OLT 20e will be described.

The OLT 20e includes a multiplexer/demultiplexer 21e, a plurality of optical reception units 3e-1 to 3e-3, an allocation unit 22e, a recording unit 23e, a plurality of decoding units 42-1 to 42-3, and a plurality of electrical signal processing units 26f-1 to 26f-3. In the following description, the optical reception units 3e-1 to 3e-3 will be referred to as optical reception units 3e unless otherwise distinguished. In the following description, the decoding units 42-1 to 42-3 will be referred to as decoding units 42 unless otherwise distinguished. In the following description, the electrical signal processing units 26f-1 to 26f-3 will be referred to as electrical signal processing units 26f unless otherwise distinguished. In the diagram illustrated in FIG. 14, the decoding unit 42 is included in the electrical signal processing unit 26f; however, in a case where an electrical analog circuit or the like is used as the decoding unit, the decoding unit 42 may be provided at the preceding stage or the subsequent stage of the electrical signal processing unit 26f, or the decoding unit 42 may receive the output of the electrical signal processing unit 26f and input the output of the decoding unit 42 to the electrical signal processing unit 26f.

Note that, in a case where the encoding unit (encoder) of the ONU 10e or the decoding unit 42 of the OLT 20e is fixed, the allocation unit 22e (holds its fixed value, and) allocates only wavelengths and holds information on the allocated wavelengths in the recording unit 23e. At the time of allocation, the allocation unit 22e allocates the wavelengths so that codes correspond to the wavelengths multiplexed/demultiplexed by the multiplexer/demultiplexer 21e. In a case where information on a predetermined code (for example, an optical code and a value thereof, and a generator polynomial and an initial value of a churn or a scrambler) and a wavelength to be multiplexed/demultiplexed by the multiplexer/demultiplexer 21e are set in advance for each device, the allocation unit 22e may allocate the wavelength and the code by the wavelength allocation.

In FIG. 14, an example is illustrated in which the allocation unit 22e allocates a set of the wavelength to be transmitted to the ONU 10e and the code for encoding, but similarly, a set of the wavelength to be received and the code for decoding may be allocated to the OLT 20e.

The allocation unit 22e allocates a wavelength and a code to each ONU 10e. For example, the allocation unit 22e performs wavelength allocation and code allocation (for example, allocation of a generator polynomial and an initial value of a churn or a scrambler) for each ONU 10e. The wavelengths and codes to be allocated are the same as those in the above-described embodiments.

The multiplexer/demultiplexer 21e has a function similar to that of the multiplexer/demultiplexer 21. Specifically, the multiplexer/demultiplexer 21e demultiplexes the input optical signal at a wavelength associated with each channel.

The optical reception units 3e-1 to 3e-3 receive the optical signals for respective channels demultiplexed by the multiplexer/demultiplexer 21e. The optical reception units 3e-1 to 3e-3 include any of one or a plurality of receivers for direct detection, differential detectors, and coherent receivers including DC. Which receiver is to be included depends on a code to be used, a modulation method, and the like. The plurality of optical reception units 3e-1 to 3e-3 having different wavelengths to be received can be formed into one receiver by making an intermediate frequency, which is a frequency difference between an optical signal and light of local light, different for each wavelength to be received to an extent that the signal can be demodulated. The optical reception units 3e-1 to 3e-3 convert the received optical signals into electrical signals and output the electrical signals to the decoding units 42-1 to 42-3. The optical reception units 3e-1 to 3e-3 are provided for respective wavelength associated with the ONUs 10e. For example, one optical reception unit 3e receives an optical signal having a wavelength for one ONU 10e.

The electrical signal processing units 26f-1 to 26f-3 process the electrical signals decoded by the decoding units 42.

Information on each ONU 10e is recorded in the recording unit 23e. Specifically, the recording unit 23e records information on the wavelength and the code in association with each ONU 10e.

The decoding units 42-1 to 42-3 decode the input electrical signals by performing decoding with the allocated codes for respective wavelengths allocated to the ONUs 10e, for example, decoding based on the generator polynomial and the initial value of the churn or the scrambler, on the basis of information on the wavelength and the code recorded in the recording unit 23e.

Next, processing of the optical transmission system 100e in the sixth embodiment will be specifically described.

The processing of the optical transmission system 100e in the sixth embodiment is the same as that in the first embodiment illustrated in FIG. 3 except that decoding is performed after photoelectric conversion. Description of similar processing will be omitted.

The allocation unit 22e allocates a wavelength and a code for each ONU 10e. For example, it is assumed that the allocation unit 22e allocates the wavelength λ1 and the first code to the ONU 10e-1, allocates the wavelength λ2 and the second code to the ONU 10e-2, and allocates the wavelength λ3 and the third code to the ONU 10e-3.

As described above, the allocation unit 22e varies the codes to be allocated to the ONUs 10e to which the wavelengths corresponding to the wavelengths in a range where the wavelengths of the ONUs 10e may drift are allocated, and the codes to be allocated to the ONUs 10e corresponding to the wavelengths in a range where there is no possibility of drift may be the same. Here, the adjacent wavelengths are set in the range, and between the ONUs 10e to which the adjacent wavelengths are allocated, at least different codes, for example, codes of different values, different generator polynomials or different initial values of the churn or the scrambler are allocated.

The allocation unit 22e outputs an optical signal including information on the allocated wavelength and code to the optical fiber. The optical splitter 30 splits the optical signal transmitted from the OLT 20e. That is, the optical splitter 30 broadcasts the optical signal transmitted from the OLT 20e. The optical signal split by the optical splitter 30 is input to each of the ONUs 10e-1 to 10e-3.

Each of the ONUs 10e-1 to 10e-3 acquires information on the wavelength and code allocated thereto from the input optical signal.

The ONUs 10e-1 to 10e-3 generate the first to third transmission data encoded by using the codes allocated to the respective devices. As an example, a description will be given of the first transmission data generated by the ONU 10e-1 to which a churn or a scrambler having a different generator polynomial and initial value is allocated as a code. The ONU 10e-1 generates the first transmission data by encoding the data to be transmitted by applying the allocated churn or scrambler, that is, causing the data to pass through a shift register, an optical or electrical splitter, a delayer, an adder, and the like. The ONUs 10e-1 to 10e-3 transmit the generated first to third transmission data to the OLT 20e at the allocated wavelengths.

The first transmission data, the second transmission data, and the third transmission data transmitted from the respective ONUs 10e-1 to 10e-3 are input to the optical splitter 30. The optical splitter 30 generates a multiplexed signal by merging the first transmission data, the second transmission data, and the third transmission data, and the optical splitter 30 outputs the multiplexed signal to the OLT 20e.

The OLT 20e receives the multiplexed signal output from the optical splitter 30. The multiplexer/demultiplexer 21e demultiplexes the input multiplexed signal at a wavelength for each channel. For example, the multiplexer/demultiplexer 21e demultiplexes the input multiplexed signal at the wavelength of the channel 1, the wavelength of the channel 2, and the wavelength of the channel 3. As a result, the optical signal having the wavelength λ1 is input to the optical reception unit 3e-1, the optical signal having the wavelength λ2 is input to the optical reception unit 3e-2, and the optical signal having the wavelength λ3 is input to the optical reception unit 3e-3.

The optical reception units 3e-1 to 3e-3 performs optical detection on the input optical signals. As a result, the input optical signals are converted into electrical signals. The optical reception units 3e-1 to 3e-3 output the converted electrical signals to the electrical signal processing units 26f. In the electrical signal processing units 26f, the electrical signals are passed to the decoding units 42-1 to 42-3.

The decoding units 42-1 to 42-3 decode the input electrical signals on the basis of the information recorded in the recording unit 23e. The decoding unit 42-1 will be specifically described as an example. First, the decoding unit 42-1 refers to the recording unit 23e and acquires information on the code associated with the ONU 10e. Next, the decoding unit 42-1 decodes the input electrical signal on the basis of the acquired information on the code. For example, if the code is a churn, the churn is restored, or if the code is a scrambler, descrambling is performed, or if the code is a code for decoding by differential detection, the electrical signal is decoded by performing sampling, delay addition, phase shift, or addition/subtraction.

Other processing of the decoding units 42-1 to 42-3 is similar to that of the decoding units 24-1 to 24-3 of the first embodiment.

According to the optical transmission system 100e configured as described above, the OLT 20e includes the allocation unit 22e that allocates different wavelengths to the respective plurality of ONUs 10e, and allocates at least different codes to the wavelengths allocated to the ONUs 10e that may leak, here, the ONUs 10e to which adjacent wavelengths are allocated, and the decoding units 42 that decode the transmission data transmitted from the plurality of ONUs 10e using the codes associated with the respective allocated wavelengths. As described above, the decoding units 42 decode the transmission data of the respective ONUs 10e on the basis of the codes associated with the respective ONUs 10e. As a result, even in a case where an adjacent wavelength leaks, a signal of the leaking wavelength is not easily decoded as a signal of the leakage destination. It is therefore possible to reduce the influence of the wavelength deviation, particularly, a risk of communicating with an unintended communication destination.

### Seventh Embodiment

In the seventh embodiment, in an OLT, an optical signal demultiplexed at a wavelength of each ONU or channel is decoded by including not only a decoding unit that decodes a code corresponding to an electrical signal of a desired ONU or channel, that is, the wavelength, but also a decoding unit that decodes a code of an electrical signal of an ONU that may cause drift, for example, an ONU of an adjacent wavelength. Then, the OLT detects presence or absence of a signal decoded with a code of an ONU that may cause drift, and detects presence or absence of a wavelength of an ONU or a channel that may cause drift, for example, a leaking optical signal due to a drift of a signal of an adjacent wavelength.

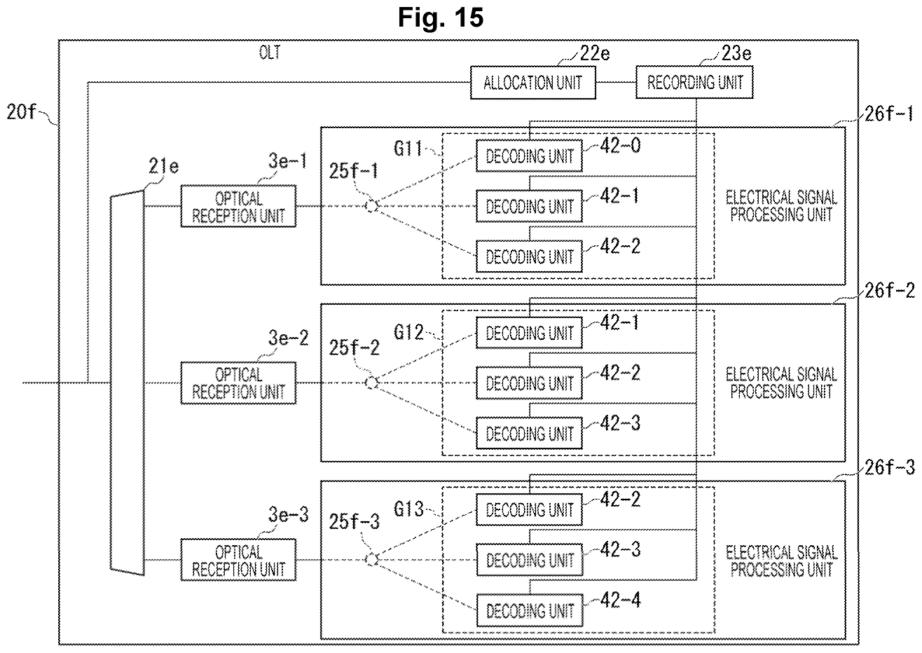

FIG. 15 is a diagram illustrating a configuration of an OLT 20f in an optical transmission system 100f in the seventh embodiment.

The optical transmission system 100f includes a plurality of ONUS 10e-1 to 10e-3, an OLT 20f, and an optical splitter 30. In the seventh embodiment, since the configuration of the OLT 20f is different from the sixth embodiment, only the OLT 20f will be described.

The OLT 20f performs processing similar to that of the sixth embodiment regarding processing from allocation of other wavelengths and codes to decoding. The OLT 20f is different from the sixth embodiment in processing after decoding, and that the signal for each wavelength is decoded even in the decoding unit for a code corresponding to a wavelength that may leak.

The OLT 20f includes a multiplexer/demultiplexer 21e, a plurality of optical reception units 3e-1 to 3e-3, an allocation unit 22e, a recording unit 23e, a plurality of decoding units 42-0 to 42-4, a plurality of splitters 25f-1 to 25f-3, and a plurality of electrical signal processing units 26f-1 to 26f-3. In the diagram illustrated in FIG. 15, the plurality of decoding units 42-0 to 42-4 and the plurality of splitters 25f-1 to 25f-3 are included in electrical signal processing units 26f, but the plurality of decoding units 42-0 to 42-4 and the plurality of splitters 25f-1 to 25f-3 may be provided outside the electrical signal processing units 26f.

When allocating a set of a wavelength to be received and a code for decoding to the OLT 20f, the allocation unit 22e allocates the wavelength, a code (the first code, or a code to be allocated to a first decoding unit) corresponding to the wavelength, and a code (the second code, or a code to be allocated to a second decoding unit) allocated to the ONU to which a wavelength that is highly likely to leak is allocated, to a channel corresponding to the wavelength.

The multiplexer/demultiplexer 21e demultiplexes an input optical signal at a wavelength for each ONU 10e, that is, for each channel. The optical signals demultiplexed by the multiplexer/demultiplexer 21e are input to the optical reception units 3e-1 to 3e-3. The optical signal output from an output for the channel 1 of the multiplexer/demultiplexer 21e is input to the optical reception unit 3e-1, the optical signal output from an output for the channel 2 is input to the optical reception unit 2, and the optical signal output from an output for the channel 3 is input to the optical reception unit 3e-3.

Outputs of the optical reception units 3e-1 to 3e-3 are input to the electrical signal processing units 26f-1 to 26f-3, respectively.

In the electrical signal processing units 26f-1 to 26f-3, the splitters 25f-1 to 25f-3 distribute electrical signals to the decoding units 42. The splitter 25f-1 is connected to the decoding unit 42-1 as the first decoding unit and the decoding units 42-0 and 42-2 as second decoding units, the splitter 25f-2 is connected to the decoding unit 42-2 as the first decoding unit and the decoding units 42-1 and 42-3 as the second decoding units, and the splitter 25f-3 is connected to the decoding unit 42-3 as the first decoding unit and the decoding units 42-2 and 42-4 as the second decoding units. Hereinafter, the decoding units 42-0 to 42-2 connected to the splitter 25f-1 are referred to as a first decoding group G11, the decoding units 42-1 to 42-3 connected to the splitter 25f-2 are referred to as a second decoding group G12, and the decoding units 42-2 to 42-4 connected to the splitter 25f-3 are referred to as a third decoding group G13.

The electrical signal processing units 26f-1 to 26f-3 process the electrical signals decoded by the decoding units 42. Specifically, the electrical signal processing units 26f-1 to 26f-3 detect a signal of a code allocated to another channel on the basis of the electrical signal, thereby detecting presence or absence of a signal of the other channel, for example, an optical signal in which a signal from a channel to which an adjacent wavelength is allocated causes wavelength drift and has leaked into a signal of a wavelength of a host channel. For example, when detecting a significant signal corresponding to a code of another ONU 10e, the electrical signal processing units 26f-1 to 26f-3 detect presence of leakage due to the drift of the signal from the ONU 10e detected.

The first decoding group G11 is included in the electrical signal processing unit 26f-1. The second decoding group G12 is included in the electrical signal processing unit 26f-2. The third decoding group G13 is included in the electrical signal processing unit 26f-3.

When detecting that there is a drift, the electrical signal processing units 26f-1 to 26f-3 may notify a notification target ONU 10e of an instruction to restore the wavelength drift directly or via the electrical signal processing unit 26f corresponding to the ONU 10e. In the case of a communication device such as the same OLT 20f communicating with the ONU 10e having the wavelength drift, the OLT 20f notifies the ONU 10e. Although a transmitter for communicating with the ONU 10e is not illustrated on the OLT 20f side in FIG. 15, the electrical signal processing unit 26f causes the transmitter to perform notification of the instruction. In a case where the electrical signal processing unit 26f is shared between channels, processing is performed in the electrical signal processing unit 26f; however, in the case of channels using separate electrical signal processing units 26f, communication is performed for that, and the notification of the instruction is performed. In a case were detection is performed by a communication device not communicating with the ONU 10e having the wavelength drift, a communication device such as the communicating OLT 20f is caused to perform notification of the instruction.

For the instruction of notification, for example, the electrical signal processing units 26-1 to 26-3 may set an instruction of wavelength setting for the corresponding ONU 10e and use the instruction, or may divert exchange with the existing ONU 10e. For example, an instruction such as restart, deletion of an authentication state, or reconnection may be used instead. When the influence of the drift is significant, it is desirable to instruct the ONU 10e to temporarily stop the transmission. In addition, an instruction may be given in a form of prompting resetting, restarting, or reconnection on the ONU 10 side, by performing a notification of communication quality degradation such as SD before an error rate of an uplink signal increases, reducing the signal strength of a downlink signal, increasing the error rate, or suppressing signal transmission to a device on the upstream side.

From a viewpoint of suppressing an influence on the notification target ONU 10e, when detecting that there is the drift, the electrical signal processing units 26f-1 to 26f-3 may perform notification to increase the signal strength of the uplink signal of a channel to which leakage has occurred, or may decrease the signal strength of the uplink signal of the ONU 10e of a channel from which leakage has occurred, or may stop transmission, restart, or remove registration.

Further, the electrical signal processing units 26f-1 to 26f-3 perform signal processing not to transmit a signal decoded with a code associated with another ONU 10e to a higher-level device. This processing is similar to that of the second embodiment, and thus description thereof is omitted.

According to the optical transmission system 100f configured as described above, a plurality of decoding groups is connected together each including at least the decoding unit 42 (first decoding unit) that decodes a signal of a desired wavelength, and the decoding unit 42 (second decoding unit) that decodes a code of the ONU 10e using, for example, an adjacent wavelength that may leak, and the electrical signal processing unit 26f is included that detects presence or absence of leakage, on the basis of a decoding result of the decoding unit that decodes the code of the ONU 10e using the adjacent wavelength, for example. The plurality of decoding units 42 belonging to the plurality of decoding groups perform decoding on the basis of different codes, and in a case where a signal is detected, the electrical signal processing unit 26f notifies the notification target ONU 10e among the plurality of ONUS 10e directly or via another electrical signal processing unit 26f. As a result, signal leakage can be detected, and improvement can be requested to the ONU 10e in a case where signal leakage occurs. As a result, the influence of the wavelength deviation can be suppressed.

Further, the optical transmission system 100f performs signal processing not to transfer the leaking signal to a higher-level device. As a result, it is possible to prevent an unnecessary signal from being transferred to the higher-level device as a signal of an ONU 10 or a channel different from the original one.

A modification of the seventh embodiment will be described.

Although a configuration has been described in which the OLT 20f in the seventh embodiment includes a plurality of decoding groups, the OLT 20f may include one decoding group. For example, the OLT 20f may include the first decoding group G11. In the case of such a configuration, the OLT 20f includes the optical reception unit 3e, the allocation unit 22e, the recording unit 23e, the splitter 25f-1, the decoding units 42-0 to 42-2 belonging to the first decoding group G1, and the electrical signal processing unit 26f-1.

### Eighth Embodiment

In the eighth embodiment, an OLT detects an output of a leakage source channel in a leakage destination channel, and adds the detected output of the channel to an output of a channel from which leakage has occurred, and performs processing of complementing a signal of the leakage source channel with an electrical signal.

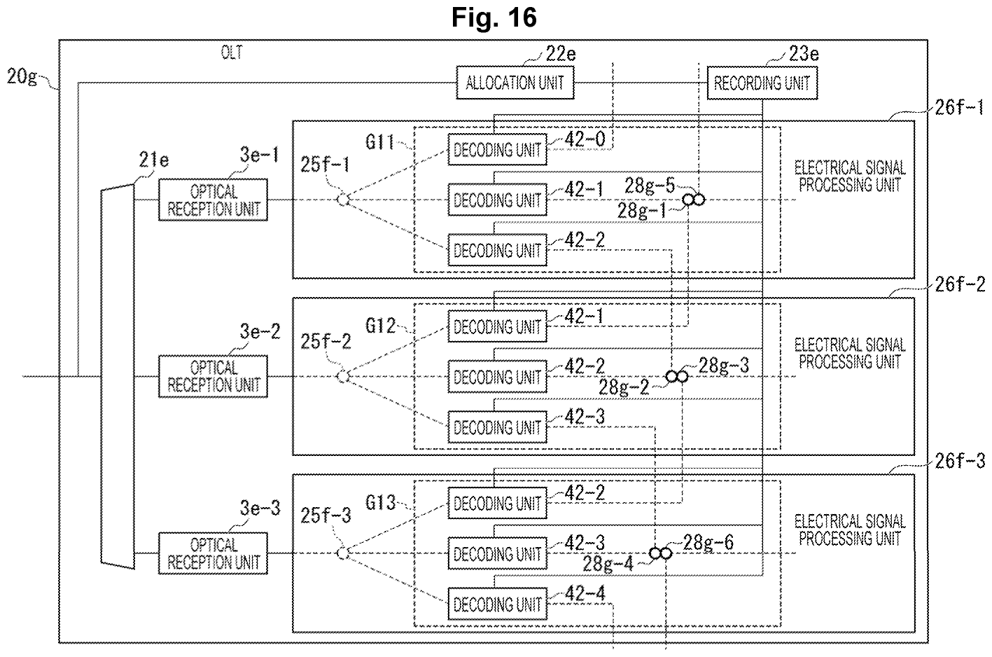

FIG. 16 is a diagram illustrating a configuration of an OLT 20g in an optical transmission system 100g in the eighth embodiment.

The optical transmission system 100g includes a plurality of ONUS 10e-1 to 10e-3, the OLT 20g, and an optical splitter 30. In the eighth embodiment, since the configuration of the OLT 20f is different from the seventh embodiment, only the OLT 20g will be described.

The OLT 20g performs processing similar to that of the seventh embodiment regarding processing from allocation of the wavelengths and the codes to decoding. The OLT 20g is different from the seventh embodiment in processing after decoding.

The OLT 20g includes a multiplexer/demultiplexer 21e, a plurality of optical reception units 3e-1 to 3e-3, an allocation unit 22e, a recording unit 23e, a plurality of decoding units 42-0 to 42-4, a plurality of splitters 25f-1 to 25f-3, a plurality of electrical signal processing units 26f-1 to 26f-3, and addition units 28g-1 to 28g-6. In the diagram illustrated in FIG. 16, the plurality of decoding units 42-0 to 42-4, the plurality of splitters 25f-1 to 25f-3, and the addition units 28g-1 to 28g-6 are included in electrical signal processing units 26f, but the plurality of decoding units 42-0 to 42-4, the plurality of splitters 25f-1 to 25f-3, and the addition units 28g-1 to 28g-6 may be provided outside the electrical signal processing units 26f. Hereinafter, differences from the seventh embodiment will be described.

The decoding unit 42-0 to 42-4 perform processing similar to that of functional units having the same names in the seventh embodiment. Further, the decoding units 42-0 to 42-4 output the electrical signals decoded with the codes allocated to the ONUs 10e of the adjacent wavelengths to the addition units 28g provided in paths that output the electrical signals of the ONUs 10e.

The addition units 28g-1 to 28g-6 add the electrical signals output from the decoding units 42.

Next, processing of the optical transmission system 100g in the eighth embodiment will be specifically described. In the first decoding group G11, the decoding unit 42-1 (first decoding unit) decodes the electrical signal having the wavelength λ1 with the code allocated to the ONU 10e of the wavelength, and the decoding units 42-0 and 42-2 (second decoding units) also perform decoding with the codes corresponding to the ONU 10e of the wavelengths that may leak, for example, the wavelengths λ0 and λ2 as the adjacent wavelengths. The code corresponding to the ONU 10e of the wavelength λ2 is a code corresponding to the ONU 10e of the adjacent wavelength in the first decoding group G11, but is a code corresponding to the ONU 10e to be originally decoded in the second decoding group G12. Thus, the decoding unit 42-2 of the first decoding group G11 included in the electrical signal processing unit 26f-1 outputs the decoded electrical signal to the addition unit 28g-2 provided on the output path of the decoding unit 42-2 of the second decoding group G12 included in the electrical signal processing unit 26f-2.

Although exemplification has been made with addition of the output of the decoding unit 42-1 of the first decoding group G11 included in the electrical signal processing unit 26f-1 to the output of the decoding unit 42-1 of the second decoding group G12 included in the electrical signal processing unit 26f-2, if there is the 0th decoding group G0 included in the electrical signal processing unit 26f-0 (not illustrated), addition of the output of the decoding unit 42-0 of the first decoding group G11 included in the electrical signal processing unit 26f-1 to the decoding unit 42-0 of the 0th decoding group G0 included in the electrical signal processing unit 26f-0 is similar. In a case where the multiplexer/demultiplexer 21e is of the loop type and the electrical signal processing unit 26f-3 corresponds to the electrical signal processing unit 26f-0, addition of the output of the decoding unit 42-0 of the first decoding group G11 included in the electrical signal processing unit 26f-1 to the output of the decoding unit 42-3 of the third decoding group G13 included in the electrical signal processing unit 26f-3 is similar.

Also in the second decoding group G12 and the third decoding group G13, processing similar to that of the first decoding group G11 described above is performed.

With the above processing, the addition unit 28g-1 adds together the electrical signal output from the decoding unit 42-1 belonging to the first decoding group G11 and the electrical signal output from the decoding unit 42-1 belonging to the second decoding group G12. The addition units 28g-2 to 28g-6 also performs addition of the optical signals output from the respective plurality of decoding units 42 connected by the solid line or the dotted line illustrated in FIG. 16.

Note that, also in the present embodiment, similarly to the third embodiment, as a modification, the output of the leakage source channel from which leakage has occurred in the leakage destination channel to which leakage has occurred is detected, and instead of adding the detected output to the output of the leakage source channel from which leakage has occurred, the detected output may be subtracted from the output of the leakage destination channel to which leakage has occurred to improve the signal of the leakage destination channel, or the detected output may be added to the output of the leakage source channel from which leakage has occurred, and subtracted from the output of the leakage destination channel to which leakage has occurred. In the latter case, to split the output, it is desirable to perform proportional distribution or amplify the split output.

Note that, in a case where the addition unit 28g performs addition or subtraction of the electrical signal, it is desirable to perform the addition before performing 0/1 determination, error correction, restoring descrambling, or hard determination by a discriminator. The addition may be performed after performing multiplication by a coefficient depending on the certainty obtained from the likelihood information or the like. However, in a case where it does not contribute to SN improvement, such as a case where the certainty is not improved, it is desirable to have a mechanism for switching not to perform addition.

According to the optical transmission system 100g configured as described above, the OLT 20g decodes the electrical signal of the leaking wavelength and adds the electrical signal of the wavelength to the output signal of the decoding unit 42 that decodes the signal, to complement the signal that has leaked. As a result, even in a case where the reception light strength is degraded due to the wavelength deviation, it is possible to suppress degradation of the signal quality.

A modification of the eighth embodiment will be described.

The optical transmission system 100g in the eighth embodiment may be modified similarly to the seventh embodiment.

### Ninth Embodiment

In the ninth embodiment, an OLT detects an output of a channel from which leakage has occurred on the channel and the strength of the channel from which leakage has occurred at a channel to which leakage has occurred, subtracts, from an output of the channel to which leakage has occurred, a duplication signal obtained by multiplying the output of the channel from which leakage has occurred by the leakage strength at the channel to which leakage has occurred, and performs processing of decoding a signal of the channel from which leakage has occurred from a signal of the channel to which leakage has occurred with an electrical signal.

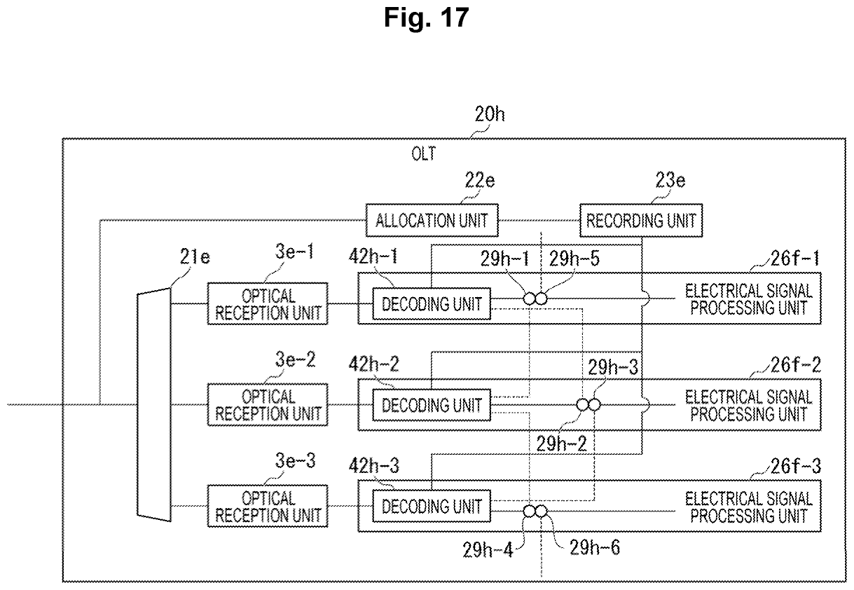

FIG. 17 is a diagram illustrating a configuration of an OLT 20h in an optical transmission system 100h in the ninth embodiment.

The optical transmission system 100h includes a plurality of ONUS 10-1 to 10-3, the OLT 20h, and an optical splitter 30. In the ninth embodiment, since the configuration of the OLT 20h is different from the sixth embodiment, only the OLT 20h will be described.

The OLT 20h performs processing similar to that of the seventh embodiment regarding processing from allocation of the wavelengths and the codes to decoding. The OLT 20h is different from the sixth embodiment in processing after decoding.

The OLT 20h includes a multiplexer/demultiplexer 21e, a plurality of optical reception units 3e-1 to 3e-3, an allocation unit 22e, a recording unit 23e, a plurality of decoding units 42h-1 to 42h-3, subtraction units 29h-1 to 29h-6, and a plurality of electrical signal processing units 26f-1 to 26f-3. In the diagram illustrated in FIG. 17, the plurality of decoding units 42h-1 to 42h-3 and the plurality of subtraction units 29h-1 to 29h-6 are included in the electrical signal processing units 26f, but the plurality of decoding units 42h-1 to 42h-3 and the plurality of subtraction units 29h-1 to 29h-6 may be provided outside the electrical signal processing units 26f.

The decoding units 42h-1 to 42h-3 perform processing similar to that of functional units having the same names in the sixth embodiment. Further, in a case where the electrical signals decoded by the decoding units 42h-1 to 42h-3 leak into the channels of the adjacent wavelengths due to the wavelength drift of the ONUS 10e, the decoding units 42h-1 to 42h-3 output the signals decoded with the codes to the subtraction units 29h provided in the paths for outputting the electrical signals of the ONUS 10e of the wavelengths that are the leakage destinations.

The subtraction units 29h-1 to 29h-6 subtract the duplication signal of the reception signal of the ONU 10e that is the leakage source from the electrical signal output from the decoding unit 42h.

Here, in FIG. 17 and the following description, it is assumed that the output of the decoding unit 42h is directly input to the subtraction unit 29h as the duplication signal of the reception signal of the ONU 10e that is the leakage source, but it is desirable to subtract the duplicate of the signal subjected to the maximum likelihood determination processing, the identification processing, or restoring.

Next, processing of the optical transmission system 100h in the ninth embodiment will be specifically described with an example in which leakage from the optical reception unit 3e-1 occurs in the optical reception unit 3e-2. The decoding unit 42h-1 that is the leakage source decodes the electrical signal having the wavelength λ1. The electrical signal processing unit 26f-1 multiplies the electrical signal decoded by the decoding unit 42h-1 by a coefficient corresponding to leakage to the adjacent wavelength. Then, the electrical signal processing unit 26f-1 outputs the multiplied electrical signal to the subtraction unit 29h-2 provided on the output path of the decoding unit 42h-2 that is the leakage destination.

Here, the coefficient may be calculated by the electrical signal processing unit 26f-1 at the leakage source capable of estimating the leakage strength due to a decrease in the signal strength, or may be calculated by the electrical signal processing unit 26f-2 at the leakage destination capable of estimating the leakage strength from an increase in the strength due to the leakage, and multiplication may be performed by either.

The decoding unit 42h-2 that is the leakage destination decodes the electrical signal having the wavelength λ2. The decoding unit 42h-2 outputs the electrical signal to the subtraction unit 29h-2 provided on the output path of decoding unit 42h-2.

Although not illustrated in FIG. 17 for simplification of description, in a case where the output for the channel 0 is in the multiplexer/demultiplexer 21e, the optical reception unit 3e-0 is connected to the output for the channel 0. Then, the electrical signal processing unit 26f-0 is connected to the subsequent stage of the optical reception unit 3e-0. In this case, the electrical signal processing unit 26f-0 outputs the multiplied signal to the subtraction unit 29h-5 provided on the output path of the decoding unit 42h-1.

Although not illustrated in FIG. 17 for simplification of description, in a case where the output for the channel 4 is in the multiplexer/demultiplexer 21e, the optical reception unit 3e-4 is connected to the output for the channel 4. Then, the electrical signal processing unit 26f-4 is connected to the subsequent stage of the optical reception unit 3e-4. In this case, the electrical signal processing unit 26f-4 outputs the multiplied signal to the subtraction unit 29h-6 provided on the output path of the decoding unit 42h-3.

With the above processing, the subtraction unit 29h-1 subtracts the electrical signal output from the decoding unit 42h-2 from the electrical signal output from the decoding unit 42h-1. The subtraction units 29h-2 to 29h-6 also perform subtraction of the signals output from the respective plurality of decoding units 42h connected by the solid line or the dotted line illustrated in FIG. 17.

Note that, in a case where the subtraction of the electrical signal is performed in the subtraction unit 29h, it is desirable to perform the subtraction with the signal before performing 0/1 determination, error correction, restoring descrambling, or hard determination by a discriminator for the signal to be subtracted, and with the signal after performing 0/1 determination, error correction, restoring descrambling, or hard determination by the discriminator for the signal from which the subtraction is performed. However, in a case where it does not contribute to SN improvement, it is desirable to have a mechanism for switching not to perform subtraction.

According to the optical transmission system 100h configured as described above, the OLT 20h subtracts the signal of the leaking wavelength from the output signal. As a result, the influence on the leakage destination can be reduced.

### Tenth Embodiment

The tenth embodiment is an embodiment in which the eighth embodiment and the ninth embodiment are combined. Specifically, in an optical transmission system 100i in the tenth embodiment, an OLT 20i detects an output of a channel from which leakage has occurred at a channel to which leakage has occurred, an output of the channel from which leakage has occurred at the channel, and the strength of the channel from which leakage has occurred at the channel to which leakage has occurred. The OLT 20i adds the output of the channel from which leakage has occurred at the channel to which leakage has occurred to the output of the channel from which leakage has occurred to complement an electrical signal of the channel from which leakage has occurred, subtracts, from the output of the channel to which leakage has occurred, a duplication signal obtained by multiplying the output of the channel from which leakage has occurred by the leakage strength at the channel to which leakage has occurred, and decodes the electrical signal of the channel from which leakage has occurred from an electrical signal of the channel to which leakage has occurred.

(Configuration in which OLT Performs Both Optical Decoding and Electrical Decoding)

In the eleventh embodiment to the fifteenth embodiment described below, the OLT performs both the optical decoding and the electrical decoding. For example, the OLT performs both the optical decoding and the electrical decoding based on a generator polynomial and an initial value of a churn or a scrambler. In the case of such a configuration, the generator polynomial and the initial value of the churn or the scrambler are allocated as a code to an ONU from the OLT. Here, it is described that the OLT performs decoding for the optical decoding and the electrical decoding with different codes, but decoding may be performed by proportionally distributing one or a plurality of codes for optical processing and electrical processing, such that a part of the decoding is optically performed using, for example, an optical circuit and the rest is electrically performed using, for example, a DSP. Hereinafter, each embodiment will be described.

### Eleventh Embodiment

In the eleventh embodiment, both the optical decoding and the electrical decoding are performed by combining the optical decoding in the first embodiment and the electrical decoding in the sixth embodiment. In the case of such a configuration, an OLT 20j in the eleventh embodiment performs processing similar to that in the first embodiment for the optical decoding, and performs processing similar to that in the sixth embodiment for the electrical decoding. For that reason, the OLT 20j in the eleventh embodiment has a configuration in which the configuration of the first embodiment and the configuration of the sixth embodiment are combined.

### Twelfth Embodiment

In the twelfth embodiment, both the optical decoding and the electrical decoding are performed by combining the optical decoding in the second embodiment and the electrical decoding in the seventh embodiment. In the case of such a configuration, an OLT 20k in the twelfth embodiment performs processing similar to that in the second embodiment for the optical decoding, and performs processing similar to that in the seventh embodiment for the electrical decoding. For that reason, the OLT 20k in the twelfth embodiment has a configuration in which the configuration of the second embodiment and the configuration of the seventh embodiment are combined.

### Thirteenth Embodiment

In the thirteenth embodiment, both the optical decoding and the electrical decoding are performed by combining the optical decoding in the third embodiment and the electrical decoding in the eighth embodiment. In the case of such a configuration, an OLT 201 in the thirteenth embodiment performs processing similar to that in the third embodiment for the optical decoding, and performs processing similar to that in the eighth embodiment for the electrical decoding. For that reason, the OLT 201 in the thirteenth embodiment has a configuration in which the configuration of the third embodiment and the configuration of the eighth embodiment are combined.

### Fourteenth Embodiment

In the fourteenth embodiment, both the optical decoding and the electrical decoding are performed by combining the optical decoding in the fourth embodiment and the electrical decoding in the ninth embodiment. In the case of such a configuration, an OLT 20m in the fourteenth embodiment performs processing similar to that in the fourth embodiment for the optical decoding, and performs processing similar to that in the ninth embodiment for the electrical decoding. For that reason, the OLT 20m in the fourteenth embodiment has a configuration in which the configuration of the fourth embodiment and the configuration of the ninth embodiment are combined.

### Fifteenth Embodiment

In the fifteenth embodiment, both the optical decoding and the electrical decoding are performed by combining the optical decoding in the fifth embodiment and the electrical decoding in the tenth embodiment. In the case of such a configuration, an OLT 20n in the fifteenth embodiment performs processing similar to that in the fifth embodiment for the optical decoding, and performs processing similar to that in the tenth embodiment for the electrical decoding. For that reason, the OLT 20n in the fifteenth embodiment has a configuration in which the configuration of the fifth embodiment and the configuration of the tenth embodiment are combined.

Modifications of the first to fifteenth embodiments will be described.

In the first embodiment to the fifteenth embodiment, although a configuration has been described in which the optical reception unit 3 or 3e is provided for each ONU 10 or 10e, one optical reception unit 3 or 3e may receive optical signals transmitted from a plurality of ONUS 10 or 10e.

In the first embodiment to the fifteenth embodiment, although a configuration has been described in which the OLT performs the allocation of the wavelengths and the codes, a part or all of the allocation of the wavelengths and the codes may be performed by something other than the OLT. For example, the part or all of allocation of the wavelengths and the codes may be performed by an operation system (OpS), or the part or all of the allocation of the wavelengths and the codes may be performed in cooperation between users or devices.

In the first embodiment to the fifteenth embodiment, although a configuration has been described in which the optical splitter is provided between the ONU and the OLT, the optical transmission system is not limited to the optical splitter, and application is possible if it is a system including a portion where there is a wavelength that is different from a wavelength logically allocated but is physically leaked for each channel, for example, a portion as illustrated in FIG. 9 (if it is an intersection of semicircles logically, a wavelength that is in another wavelength's side from the intersection is a wavelength that physically leaks), a system that is considered to have an improvement of both.

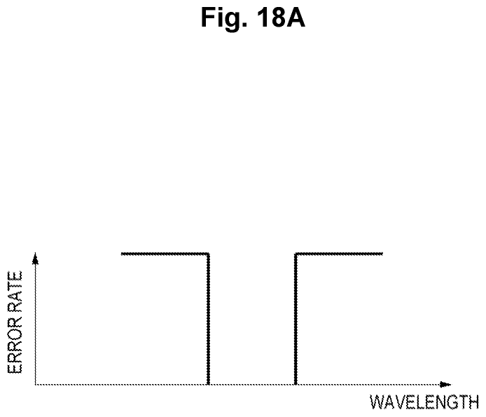

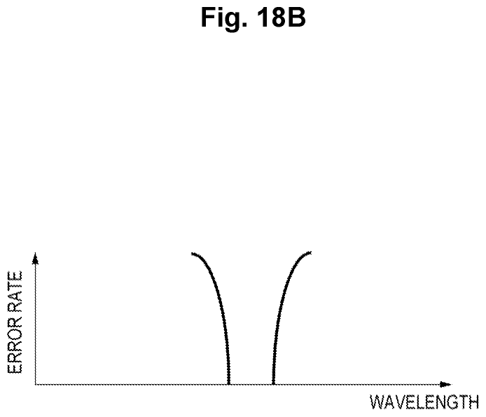

In a case where addition of an error rate is performed and used as a trigger for restoring a wavelength drift, the error rate may be added stepwise in a wavelength fluctuation range as illustrated in FIG. 18A, or may be gradually added as illustrated in FIG. 18B. In the case of gradual restoring, it is better to be gradually added.

In the fifth embodiment to the fifteenth embodiment, the following configuration may be provided at the subsequent stage of the optical reception unit 3e.

(First Configuration) As a first configuration, an amplifier, an identification and reproduction unit, and the like may be further provided in the subsequent stage of the optical reception unit 3e.

The amplifier amplifies an electrical signal. The identification and reproduction unit identifies and reproduces the electrical signal filtered by the filter.

(Second Configuration)

As a second configuration, an analog-to-digital converter, the amplifier, the filter, the decoding unit at the electrical stage, the identification and reproduction unit, and the like may be provided at the subsequent stage of the optical reception unit 3e.

The analog-to-digital converter performs analog-to-digital conversion on the electrical signal. The amplifier amplifies a digital signal. The filter filters the amplified digital signal. The decoding unit at the electrical stage decodes the digital signal filtered by the filter. The identification and reproduction unit identifies and reproduces the digital signal decoded by the decoding unit at the electrical stage.

(Third Configuration)

As a third configuration, a large-scale integration (LSI) such as an application specific integrated circuit (ASIC) or a field programmable gate array (FPGA) that acts as the analog-to-digital converter, the amplifier, the filter, the decoder at the electrical stage, the identification and reproduction unit, and the like may be provided at the subsequent stage of the optical reception unit 3e, and may be appropriately combined depending on a method of decoding or the like. Note that, it is sufficient that the LSI that acts as the analog-to-digital converter, the amplifier, the filter, the electrical stage decoder, and the identification and reproduction unit are provided as necessary.

In the first embodiment to the fifth embodiment, decoding is performed as an optical signal. This configuration is suitable in the case of a code of a wavelength or an optical frequency, or a code of a wavelength×time or an optical frequency×time. This configuration may be adopted even in the case of codes of other domains. A signal after demultiplexing or a signal before demultiplexing may be subjected to photoelectric conversion to perform processing such as decoding. In these cases, there is an effect that loss of light due to the optical splitter 30 or the multiplexers/demultiplexers 21 and 21a can be reduced. These configurations are suitable for code in the time domain, the frequency domain, or a combination thereof. Also in the case of a code including a wavelength or optical frequency domain, and a code and a receiver using a phase and a phase difference of light, processing at the electrical stage is suitable if coherent detection is used.

In the sixth embodiment to the tenth embodiment, a configuration is illustrated in which the multiplexer/demultiplexer 21e receives the optical signal for each wavelength, but wavelength selection may be performed by performing filtering at an intermediate frequency after heterodyne detection with the filter and the optical reception unit 3e.

The optical splitter 30 may be built in the OLTs 20, 20a, 20b, 20c, 20d, 20e, 20f, 20g, 20h, 20i, 20j, 20k, 201, 20m, and 20n, or the multiplexers/demultiplexers 21 and 21a may be provided outside the OLTs 20, 20a, 20b, 20c, 20d, 20j, 20k, 201, 20m, and 20n. In a case where only the separation is performed, for example, in a case where unidirectional communication is mainly performed, or in a case where different paths are used in the uplink and downlink, the optical splitter 30 may be a coupler or a splitter depending on its role. Similarly, in a case where only the separation is performed, for example, in a case where unidirectional communication is mainly performed, or in a case where different paths are used in the uplink and downlink, the multiplexers/demultiplexers 21 and 21a may be a multiplexer or a demultiplexer depending on their roles

In the first embodiment to the fifteenth embodiment, the OLTs 20, 20a, 20b, 20c, 20d, 20e, 20f, 20g, 20h, 20i, 20j, 20j, 201, 20m, and 20n do not have functions of framing and layer 2 processing for transmission to a higher-level network. The OLTs 20, 20a, 20b, 20c, 20d, 20e, 20f, 20g, 20h, 20i, 20j, 20j, 201, 20m, and 20n may have the functions of framing and layer 2 processing. Note that, in a case where the OLTs 20, 20a, 20b, 20c, 20d, 20e, 20f, 20g, 20h, 20i, 20j, 20j, 201, 20m, and 20n do not have the functions of framing and layer 2 processing, the OLTs 20, 20a, 20b, 20c, 20d, 20e, 20f, 20g, 20h, 20i, 20j, 20j, 201, 20m, and 20n effectively become optical receivers. That is, it can be considered that the OLTs 20, 20a, 20b, 20c, 20d, 20e, 20f, 20g, 20h, 20i, 20j, 20j, 201, 20m, and 20n include the optical receiver.

Some functions of the OLTs 20, 20a, 20b, 20c, 20d, 20e, 20f, 20g, 20h, 20i, 20j, 20j, 201, 20m, and 20n in the above-described embodiments may be implemented by a computer. In that case, a program for implementing this function may be recorded in a computer-readable recording medium, and the program recorded in the recording medium may be read and executed by a computer system to implement this function. Note that the “computer system” here includes hardware such as an OS and peripheral devices. In addition, the “computer-readable recording medium” refers to a portable medium such as a flexible disk, a magneto-optical disk, a ROM, or a CD-ROM, or a recording device such as a hard disk built in a computer system. Further, the “computer-readable recording medium” may include a medium that dynamically holds a program for a short time, such as a communication line in a case where the program is transmitted via a network such as the Internet or a communication line such as a telephone line, and a medium that holds a program for a certain period of time, such as a volatile memory inside a computer system serving as a server or a client in that case. In addition, the program may be for implementing a part of the functions described above, may be capable of implementing the functions described above in combination with a program already recorded in a computer system, or may be implemented by using a programmable logic device such as an FPGA.

As above, the embodiments of the present invention have been described in detail with reference to the drawings. On the other hand, the specific configuration is not limited to the embodiments, and includes design and the like without departing from the spirit of the present invention.

### INDUSTRIAL APPLICABILITY

The present invention can be applied to an optical transmission system using a WDM.

Reference Signs List

3, 3-1 to 3-3, 3e, 3e-1 to 3e-3 Optical reception unit
10-1 to 10-3, 10e-1 to 10e-3 ONU
20, 20a, 20b, 20c, 20e, 20f, 20g, 20h OLT
30 Optical splitter
21, 21a, 21e Multiplexer/demultiplexer
22, 22e Allocation unit
23, 23e Recording unit
24-0 to 24-4, 24c-1 to 24c-3, 42-0 to 42-4, 42h-1 to 42h-3
Decoding unit
25-1 to 25-3, 25f-1 to 25f-3 Splitter
26-1 to 26-3, 26f-1 to 26f-3 Electrical signal
processing unit
28-1 to 28-6, 28g-1 to 28g-6 Addition unit
29-1 to 29-6, 29h-1 to 29h-6 Subtraction unit

1. An optical transmission system comprising a plurality of optical transmission devices and an optical reception device and performing communication by wavelength division multiplexing, wherein
the plurality of optical transmission devices each includes
a transmission unit that encodes transmission data on a basis of an allocated code and output the transmission data to an optical transmission line at an allocated wavelength, and
different codes are allocated to the plurality of optical transmission devices to which different wavelengths are allocated, and
the optical reception device includes
one or a plurality of decoding units that decodes an optical signal for each wavelength transmitted via the optical transmission line by wavelength multiplexing division into the transmission data transmitted from the plurality of optical transmission devices on the basis of the allocated code.

2. The optical transmission system according to claim 1, wherein
the optical reception device further includes
an optical reception unit connected to the one or the plurality of decoding units, and
in a case where one of the decoding units decodes the optical signal for each wavelength, the one of the decoding units is a first decoding unit and decodes the optical signal with one of the codes corresponding to the wavelength, and
in a case where the plurality of decoding units decodes the optical signal for each wavelength, the plurality of decoding units is the first decoding unit and one or a plurality of second decoding units, and the second decoding units each decodes the optical signal with one of the codes corresponding to a wavelength that is likely to leak into the wavelength.

3. The optical transmission system according to claim 1, wherein
in the optical reception device,
the one or the plurality of decoding units each is connected to an optical reception unit that receives the optical signal for each wavelength, and
in a case where one of the decoding units decodes an output of the optical signal for each wavelength received by the optical reception unit, the one of the decoding units is a first decoding unit and decodes the output with one of the codes corresponding to the wavelength, and
in a case where the plurality of decoding units decodes the output of the optical signal for each wavelength received by the optical reception unit, the plurality of decoding units is the first decoding unit and one or a plurality of second decoding units, and the second decoding units each decodes the output with one of the codes corresponding to a wavelength that is likely to leak into the wavelength.

4. The optical transmission system according to claim 2, wherein
in a case where leakage is detected on a basis of decoding results of the second decoding units, a notification is given to one of the optical transmission devices corresponding to one of the codes of a leakage source.

5. The optical transmission system according to claim 2, further comprising
an addition unit that adds outputs of the second decoding units that are leakage destinations to an output of the first decoding unit that is a leakage source.

6. The optical transmission system according to claim 2, further comprising
a subtraction unit that subtracts outputs of the second decoding units that are leakage destinations from an output of the first decoding unit that is a leakage destination.

7. The optical transmission system according to claim 2, further comprising
a subtraction unit that subtracts, from an output of the first decoding unit that is a leakage destination, a duplication signal obtained by multiplying an output of the first decoding unit that is a leakage source by a coefficient corresponding to leakage into the leakage destination.

8. An optical reception device in the optical transmission system according to claim 1.

9. An optical transmission device in the optical transmission system according to claim 1.
